(19) United States
(12) Patent Application Publication
(10) Pub. No.: US 2026/0231231 A1
(43) Pub. Date: Aug. 6, 2026

(54) DYNAMIC RANDOM ACCESS CHANNEL (RACH) OCCASION (RO) ACTIVATION FOR A SUBSET OF ROs

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 19/382,228

(22) Filed: Nov. 6, 2025

Related U.S. Application Data
(60) Provisional application No. 63/755,180, filed on Feb. 6, 2025.

(51) Int. Cl. H04W 74/0833; H04W 76/27

(52) U.S. Cl. CPC H04W 74/0833; H04W 76/27

(57) ABSTRACT

Certain aspects of the present disclosure provide techniques for wireless communications. An example method includes obtaining an indication of a first random access channel (RACH) configuration that is associated with a first plurality of RACH occasions; obtaining an activation indication to activate a subset of the first plurality of RACH occasions, wherein the subset of the first plurality of RACH occasions is associated with one or more first time periods, and wherein the subset of the first plurality of RACH occasions is associated with a plurality of synchronization signal blocks (SSBs); and sending, in a first RACH occasion of the subset of the first plurality of RACH occasions, a random access signal to initiate a RACH procedure.

### CROSS-REFERENCE TO RELATED APPLICATION(S)

The present Application for Patent claims benefit of and priority to U.S. Provisional Application No. 63/755,180, filed Feb. 6, 2025, which is herein incorporated by reference in its entirety.

### INTRODUCTION

### Field of the Disclosure

Aspects of the present disclosure relate to wireless communications, and more particularly, to techniques for random access channel (RACH) configuration adaptation.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining an indication of a first random access channel (RACH) configuration that is associated with a first plurality of RACH occasions; obtaining an activation indication to activate a subset of the first plurality of RACH occasions, wherein the subset of the first plurality of RACH occasions is associated with one or more first time periods, and wherein the subset of the first plurality of RACH occasions is associated with a plurality of synchronization signal blocks (SSBs); and sending, in a first RACH occasion of the subset of the first plurality of RACH occasions, a random access signal to initiate a RACH procedure.

Certain aspects provide a method for wireless communications by a network entity. The method includes sending an indication of a first RACH configuration that is associated with a first plurality of RACH occasions; sending an activation indication to activate a subset of the first plurality of RACH occasions, wherein the subset of the first plurality of RACH occasions is associated with one or more first time periods, and wherein the subset of the first plurality of RACH occasions is associated with a plurality of SSBs; and obtaining, in a first RACH occasion of the subset of the first plurality of RACH occasions, a random access signal to initiate a RACH procedure.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5A depicts an example four-step random access channel (RACH) procedure.

FIG. 5B depicts an example two-step RACH procedure.

FIG. 6 depicts a process flow for communications in a network between a network entity and a UE to dynamically activate a subset of RACH occasions (ROs) of a RACH configuration, where the subset of ROs are associated with one or more time periods.

FIG. 7 depicts example time periods associated with an example RACH configuration.

FIG. 8 depicts example associations between RO subset mask indexes and patterns of periods for a given period type.

FIG. 9 depicts example associations between RO subset mask indexes and patterns of a first given period time in a second given period type.

FIG. 10 depicts example associations between RO subset mask indexes and patterns of periods for various period types.

FIG. 11A depicts example associations between RO subset mask indexes and patterns of periods.

FIG. 11B depicts example associations between RACH configuration periodicities and period types.

FIG. 12 depicts a process a flow for communications in a network between a network entity and a UE to dynamically activate a subset of ROs of one or more RACH configurations, where the subset of ROs are associated with one or more times periods.

FIG. 13 depicts example activation of a subset of ROs of one or more RACH configurations.

FIG. 14 depicts example associations between radio resource control (RRC) modes of a UE and RACH configurations.

FIG. 15 depicts example groups of RACH configurations.

FIG. 16 depicts a process flow for communications in a network between a network entity and a UE to dynamically activate a subset of RACH occasions (ROs) of a RACH configuration, where the subset of ROs are associated with one or more time periods.

FIG. 17 depicts example time periods associated with an indicated offset time and duration.

FIG. 18 depicts a method for wireless communications.

FIG. 19 depicts another method for wireless communications.

FIG. 20 depicts aspects of an example communications device.

FIG. 21 depicts aspects of an example communications device.

### DETAILED DESCRIPTION

Aspects of the present disclosure provide apparatuses, methods, processing systems, and computer-readable mediums for triggering random access channel (RACH) configuration adaptation, and more specifically, triggering the activation of a subset of configured RACH occasions (ROs) for random access communications. The subset of ROs may correspond to time resources and frequency resources (“time-frequency resources”), configured for random access communications, that are associated with (e.g., occur during) one or more time periods. Accordingly, triggering the activation of the subset of ROs may result in the activation of ROs that are close together in time (e.g., altogether close in time or subsets of the activated ROs are close together in time), which may allow for increased network energy savings and improved network resource usage, as described in further detail below.

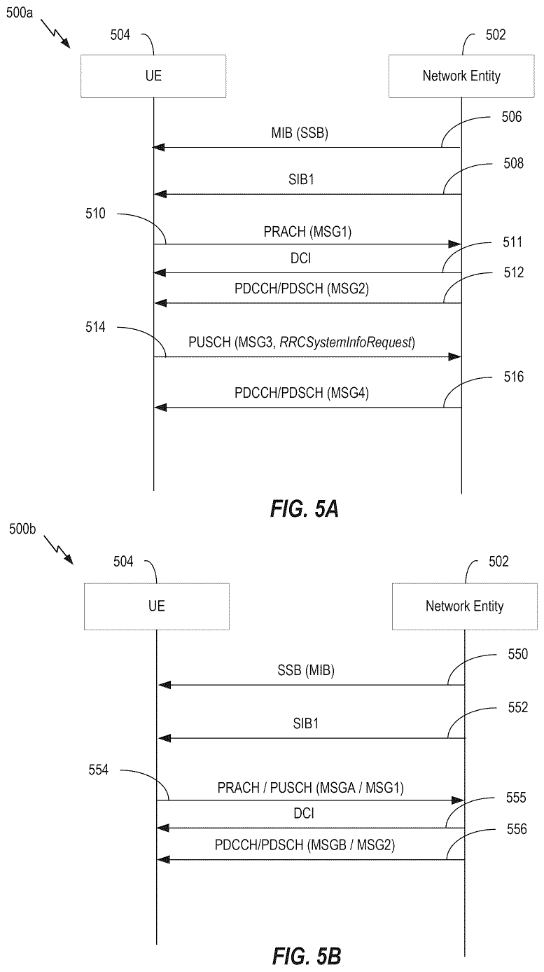

In certain wireless communication systems (e.g., 5G New Radio (NR) systems and/or any future wireless communications system), a user equipment (UE) may communicate with a network entity (e.g., a base station (BS)) using a RACH procedure, for example, for initial access to the network entity, for beam failure recovery, to obtain timing information (e.g., a timing advance), to request uplink communication resources, to request system information, etc. An example RACH procedure may begin with the UE sending a random access signal (e.g., a preamble) on a physical RACH (PRACH) in an RO, which may include one or more time-frequency resources. Upon successful reception of the random access signal, the network entity may send a response (referred to as a “random access response”) to the random access signal within a random access response window (e.g., a time window). For example, in certain aspects, the network entity may send a physical downlink control channel (PDCCH) communication including downlink control information (DCI) that schedules the random access response on a physical downlink shared channel (PDSCH). The random access response may include an uplink scheduling grant. On receiving the response, the UE may send a request to setup a connection with the network entity, and then, the network entity may reply with a contention resolution response. Certain aspects associated with random access communications are further described herein, for example, with respect to FIGS. 5A and 5B.

In certain aspects, a UE may obtain, from a network entity, a configuration for random access communications (also referred to herein as a “RACH configuration”), such as to perform a RACH procedure. For example, the UE may obtain the RACH configuration via system information that is broadcast by the network entity. The RACH configuration may identify certain parameters for random access communications, such as a set of preambles and/or a duration for the random access response window. Further, in certain aspects, the RACH configuration may identify RACH occasions (ROs) corresponding to time-frequency resources configured for random access communications, such as for a random access signal transmission (e.g., preamble transmission) from the UE to the network entity.

A RACH configuration that configures multiple ROs for random access communications may help to reduce latency associated with accessing the network, such as by providing more opportunities for a UE to initiate a RACH procedure and thus establish a connection with a network entity. However, this improvement in network access time may be realized at the expense of lower energy savings for the network. For example, to save energy, a network entity may transition into a lower-power state (also referred to as a “sleep mode”) during one or more time periods, including time periods with minimal network traffic. A network entity may avoid entering into the lower-power state, however, when multiple ROs are configured during a time period. For example, to reduce the likelihood of missing a transmission from a UE, the network entity may remain in a higher-power state (also referred to as an “awake mode”), such as for extended periods of time (e.g., associated with the configured ROs), to monitor for and process random access signals, from one or more UEs, in the multiple configured ROs. Thus, network energy consumption may increase as a result of the reduced amount and/or duration of sleep periods for the network entity.

Accordingly, in an effort to increase network energy savings without impacting (or with minimal impact to) network access performance, some approaches introduce techniques for dynamically adapting ROs in a time domain. Dynamic adaptation of ROs in the time domain is a technique used to adjust the number of configured ROs that are available (e.g., activated) for random access communications, such as for a random access signal transmission (e.g., preamble transmission) from a UE to a network entity. In certain aspects, dynamic adaptation of ROs may be used to increase a number of ROs that are available for random access communications, such as for a defined period of time. After the period of time, the ROs may no longer be available for random access communications (e.g., may be deactivated), thereby enabling a network entity to transition into a lower-power state (e.g., at least until a next-in-time RO).

For example, a UE may obtain multiple RACH configurations for random access communications, including a first RACH configuration and a second RACH configuration. The first RACH configuration may configure the UE with a first set of ROs that may be used for random access communications. The second RACH configuration may configure the UE with a second set of ROs, which may be initially dormant and later activated (e.g., made available) for random access communications. In some examples, the first RACH configuration may be a “legacy RACH configuration” associated with fixed ROs (e.g., the first set of ROs), which may not adjust to changing network conditions, such as increased communication traffic. Further, the second RACH configuration may be an “additional RACH configuration,” associated with the legacy RACH configuration, added to accommodate newer wireless devices (e.g., such as UEs that are configured for current or future generations of wireless communications and that have advanced circuitry and/or processing capabilities) and/or varying network requirements, such as to improve efficiency and reduce unnecessary network energy consumption. For example, the additional RACH configuration may be associated with additional ROs in the time domain (e.g., the second set of ROs, associated with additional RACH resources), which may be activated and deactivated over time, such as in response to changing network traffic and/or access requests. Accordingly, the additional RACH configuration may represent an adaptation to the legacy RACH configuration, providing a flexible solution that helps to balance network efficiency and energy consumption, as needed.

DCI-based adaptation is one example technique that may be used to activate RO(s) of a RACH configuration (e.g., such as additional RO(s) of an additional RACH configuration) for random access communications. DCI is a type of signaling that may be transmitted to one UE or a group of UEs on the PDCCH. For example, DCI-based adaptation may utilize DCI to dynamically adjust a RACH configuration by informing a UE about which RO(s) to activate. The UE may activate the indicated RO(s), based on receiving the DCI, such that these RO(s) (in some cases, in additional to legacy RO(s)) are available for use by the UE to initiate a RACH procedure with a network entity.

In certain aspects, the DCI may include a “PRACH mask index” used to inform a UE about which ROs, (1) associated with a single synchronization signal block (SSB) index or (2) per SSB index for multiple SSB indexes, to activate for random access signal transmission from the UE to the network entity. As used herein, an “SSB index” is a unique numerical identifier that may be assigned to a specific SSB transmitted to the UE by the network entity. For example, different sets of ROs (e.g., one or more ROs, such as additional RO(s)) configured for random access communications may be mapped to different SSB indexes. As an illustrative example, a first set of ROs may be mapped to SSB index 0, such that the first set of ROs are configured for communicating random access communications (e.g., a preamble of the RACH procedure) associated with transmission(s), to the UE, of SSB(s) associated with SSB index 0. Specifically, a UE may receive an SSB associated with SSB index 0, measure the SSB to determine a preferred beam to use for communication, and then send, in an RO of the first set of ROs, a preamble indicating the preferred beam. Similarly, a second set of ROs may be mapped to SSB index 1, such that the second set of ROs are configured for communicating random access communications (e.g., a preamble of the RACH preamble) associated with transmission(s), to the UE, of SSB(s) associated with SSB index 1. Different PRACH mask indexes may be associated with different RO(s) per SSB index (e.g., different PRACH mask indexes may be mapped to specific RO(s) per SSB index), such that when the DCI includes a PRACH mask index, the different RO(s) associated with the specific PRACH mask index are activated per SSB index or for a single SSB index.

Although aspects herein describe the use of PRACH mask indexes for DCI-based adaptation, in some other examples, PRACH mask indexes may be indicated via semi-static configuration (e.g., via a system information block 1 (SIB1)), radio resource control (RRC) configuration, and/or other types of configuration.

In some cases, it may be beneficial to activate a subset of ROs, configured for random access communications, that are close together in time rather than spread over an extended time period. For example, as described above, a network entity may consume significant power when continuously monitoring ROs for random access signals from UEs. This power consumption at the network entity may be higher for ROs that are more spread out in time than ROs that are configured to be closer together. For example, the more spread out that ROs are, the more time the network entity may need to remain in a higher-power state (e.g., an active mode), which may in turn increase energy consumption at the network entity. Further, constantly transitioning between a lower-power state and a higher-power state, such as to enable the network entity to monitor each RO individually and sleep for short periods of time between the spread out ROs in the time domain, may result in inefficient power consumption at the network entity. Accordingly, activating a subset of ROs (e.g., of a RACH configuration) that are configured closely together in time, may help achieve increased network energy savings and improve network resource usage. Further, signaling overhead associated with DCI-based activation of a subset of ROs may be less than DCI-based activation of each individual RO, where multiple ROs are activated.

A technical problem associated with techniques for RO activation, including the use of PRACH mask indexes for DCI-based adaptation, includes their inflexibility to activate a subset of ROs that are close together in time and that repeat over time (e.g., such as adjacent ROs that repeat over time). For example, as described above, DCI including a PRACH mask index may activate specific RO(s), e.g., RO(s) assigned specific RO index(es), per SSB index (e.g., such as a first RO assigned a first RO index, per SSB index). ROs with the same RO index, but associated with different SSB indexes, may be close together in a time domain and may not repeat over time. For example, ROs associated with an RO index 1 (RO1) and all SSB indexes (e.g., SSB indexes 1-3 (S1, S2, S3)) may all occur prior in time than ROs associated with an RO index 2 (RO2) and all SSB indexes (e.g., [RO1(associated with S1), RO1(S2), RO1(S3), RO2(S1), RO2(S2), RO2(S3)]). Thus, using some PRACH mask indexes to activate ROs with the same RO index, but associated with different SSB indexes, may not result in activating a subset of ROs that are distributed across multiple time frames (where the subset of ROs are close together in time). Accordingly, some PRACH mask indexes may not enable the activation of multiple RO subsets over a period of time, such as for achieving increased network energy savings over the entire period of time. Furthermore, these techniques for RO activation may be inflexible with regard to specifically which ROs are activated. For example, these ROs may be activated in an “all or nothing” fashion per RO index (or for multiple RO indexes) per SSB index, even if not all of the ROs, associated with the specified RO index (or the multiple RO indexes), are needed or desired to be activated (for example, for achieving increased network energy savings or load balancing reasons). As another example, the activation of ROs associated with a same RO index, and for more than one SSB index but for less than all SSB indexes (e.g., for ROs associated with S1and S2 but not S3), may not be capable of being activated using some PRACH mask indexes. Put differently, ROs associated with time periods that are less than or greater than an RO index periodicity may not be activated using some PRACH mask indexes.

Certain aspects described herein overcome the aforementioned technical problems associated with RACH configuration adaptation, and provide a technical benefit to the field of telecommunications. For example, certain aspects provide various mechanisms for triggering the activation of a subset of ROs for random access communications, and more specifically, ROs associated with (e.g., occurring during) one or more time periods. Triggering the activation of a subset of ROs associated with one or more time periods may result in the activation of a set of ROs that are close together in time, for example, corresponding to time resources that are near each other in a time domain, and further in some cases, repeat over time.

In certain aspects, the one or more time periods may include association period(s) for one or more RACH configurations, such that the ROs that are activated (e.g., using one or more of the mechanisms described herein) include ROs belonging to the association period(s) associated with the one or more RACH configurations. As used herein, an “association period” of a RACH configuration may refer to a time period of the smallest integer of {1,2,4,8,16} RACH configuration periods that include ROs associated with at least one instance of every SSB index. A “RACH configuration period” may refer to a time interval for which ROs are available for use by one or more UEs to access the network. Further, a RACH configuration period may comprise a configuration parameter of a RACH configuration, which defines the periodicity of the RACH resources based on the RACH configuration, regardless of whether they are valid or not.

In certain aspects, the one or more time periods may include SSB mapping cycle(s) for one or more RACH configurations, such that the ROs that are activated (e.g., using one or more of the mechanisms described herein) include ROs belonging to the SSB mapping cycle(s) associated with the one or more RACH configurations. As used herein, an “SSB mapping cycle” of a RACH configuration may refer to a time interval that includes ROs associated with an SSB index assigned to every SSB that may be transmitted. For example, SSBs associated with SSB indexes 1-3 (e.g., S1, S2, S3) may be transmitted to a UE. ROs associated with SSB index 1 (S1) may be used for random access communications associated with transmission(s) of SSB(s) associated with S1, ROs associated with SSB index 2 (S2) may be used for random access communications associated with transmission(s) of SSB(s) associated with S2, and ROs associated with SSB index 3 (S3) may be used for random access communications associated with transmission(s) of SSB(s) associated with S3. ROs associated with S1, ROs associated with S2, and ROs associated with S3 may repeat periodically in the time domain. For example, ROs may include [RO associated with S1, RO associated with S2, RO associated with S3, RO associated with S1, RO associated with S2, RO associated with S3, . . . ] (e.g., ROs associated with SSB indexes [0, 1, 2, 3, 0, 1, 2, 3, . . . ]). For this example, each SSB mapping cycle may include one RO associated with S1, one RO associated with S2, and one RO associated with S3.

In certain aspects, the one or more time periods may include association pattern period(s) for one or more RACH configurations, such that the ROs that are activated (e.g., using one or more of the mechanisms described herein) include ROs belonging to the association period(s) associated with the one or more RACH configurations. As used herein, an “association pattern period” of a RACH configuration may refer to a pattern of association periods, of the RACH configuration, over a period of 160 milliseconds (ms). An association pattern period may repeat every 160 ms because a maximum RACH configuration periodicity may be equal to 160 ms.

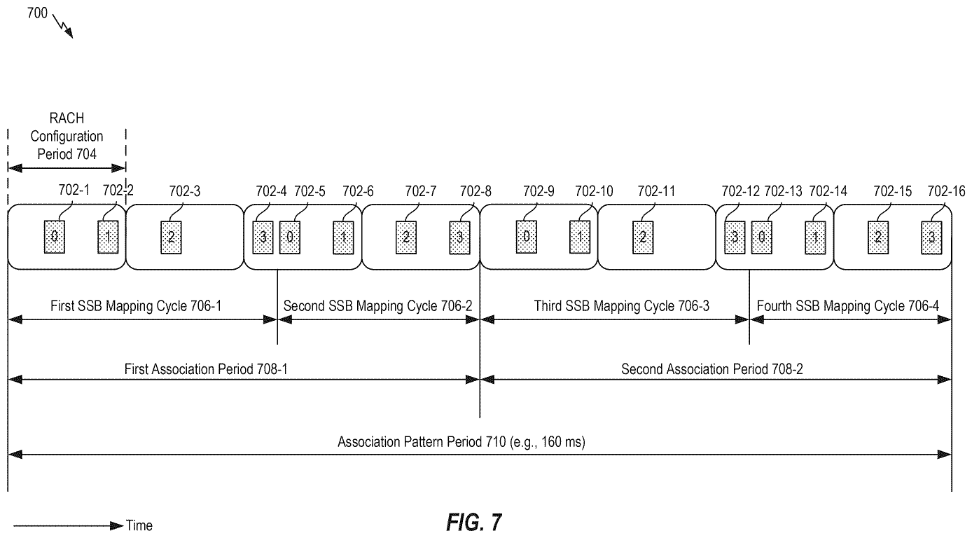

Example association periods, SSB mapping cycles, and an association pattern period for an example RACH configuration are depicted and described herein with respect to FIG. 7.

In certain aspects, the one or more time periods may include time period(s) associated with an indicated offset time and duration, and in some cases, an indicated periodicity. Accordingly, the ROs that are activated, using one or more of the mechanisms described herein, may belong to time periods defined by the indicated offset time and duration, and in some cases, the indicated periodicity.

The mechanisms described herein may utilize various signaling to trigger the activation of the subset of ROs associated with the one or more time periods. In certain aspects, the signaling may include the communication of an activation indication to activate the subset. In certain aspects, the activation indication may comprise an RO subset mask index (e.g., an “index”) associated with a pattern of periods (e.g., every odd period, two consecutive periods) for a single (given) period type (e.g., association period, SSB mapping cycle, etc.), such as to trigger the activation of ROs associated with the pattern of periods for the single period type. In certain aspects, the activation indication may comprise an RO subset mask index (e.g., an “index”) associated with a pattern of a first given period type (e.g., the first X number of association periods, every even association period, every odd association period, every even SSB mapping cycle, etc.) of a (e.g., in a) (larger) second given period type (e.g., association pattern period), such as to trigger the activation of ROs associated with the pattern of the first given period in the (larger) second given period type. In certain aspects, the activation indication may comprise an RO subset mask index (e.g., an “index”) associated with a pattern of periods and a period type, such as to trigger the activation of ROs associated with the pattern of periods and the period type. In certain aspects, the activation indication may comprise an RO subset mask index associated with a pattern of periods. Additionally, in some cases, further signaling may be used to communicate the period type. In certain aspects, the signaling may include the communication of an indication of an offset time and a duration associated with each of the time period(s). Additionally, in some cases, further signaling may be used to communicate a periodicity for the time period(s).

Certain techniques for RACH configuration adaptation described herein may provide various beneficial technical effects and/or advantages. The techniques for RACH configuration adaptation may enable improved wireless communications performance, such as more efficient network resource usage and increased network energy savings. The improved network resource usage may be attributable to the use of one or more of the mechanisms described herein, which trigger the activation of a subset of ROs associated with one or more time periods. For example, triggering the activation of a subset of ROs may result in the activation of sets of ROs that repeat in time, where each set of ROs includes ROs that are close together in time. As such, a network entity may remain awake for the one or more time periods and enter into a lower-power state during time periods outside of the one or more time periods. Further, the network entity may avoid constant switching between a lower-power state and a higher-power state for random access communication monitoring. The increased network energy savings may be attributable to the ability of the network entity to enter into the lower-power states, and in some cases, for longer periods of time than when existing techniques are used to activate one RO or multiple ROs per SSB index. As another example, triggering the activation of the subset of ROs using one or more of the mechanisms described herein may allow for increased flexibility in RO activation (e.g., when compared to the use of existing techniques), such that in some cases, network energy savings and/or load balancing may be realized during specific time periods. Further, the mechanisms may allow for reduced overhead when activating ROs associated with multiple time periods.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

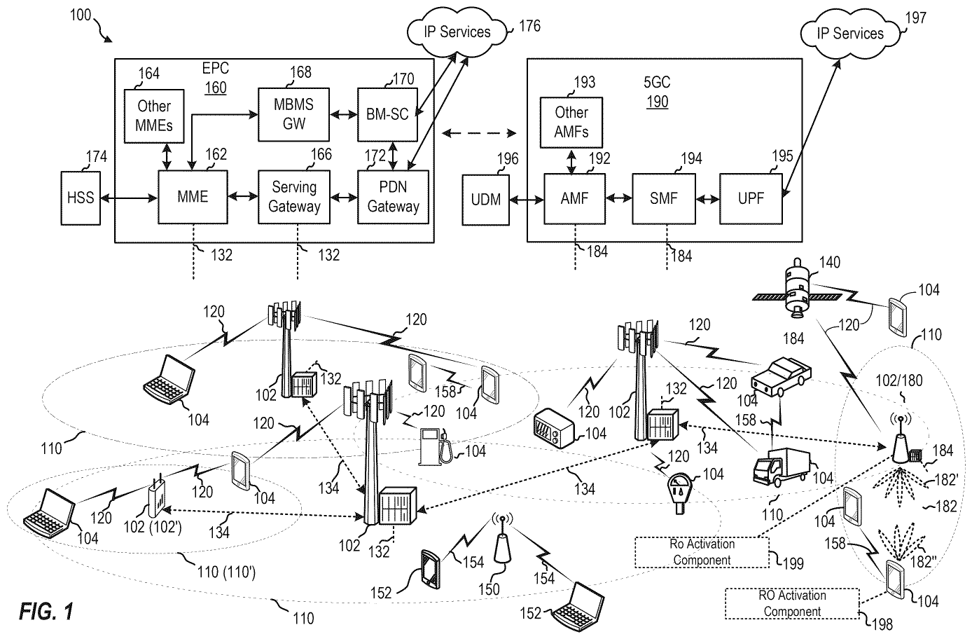

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

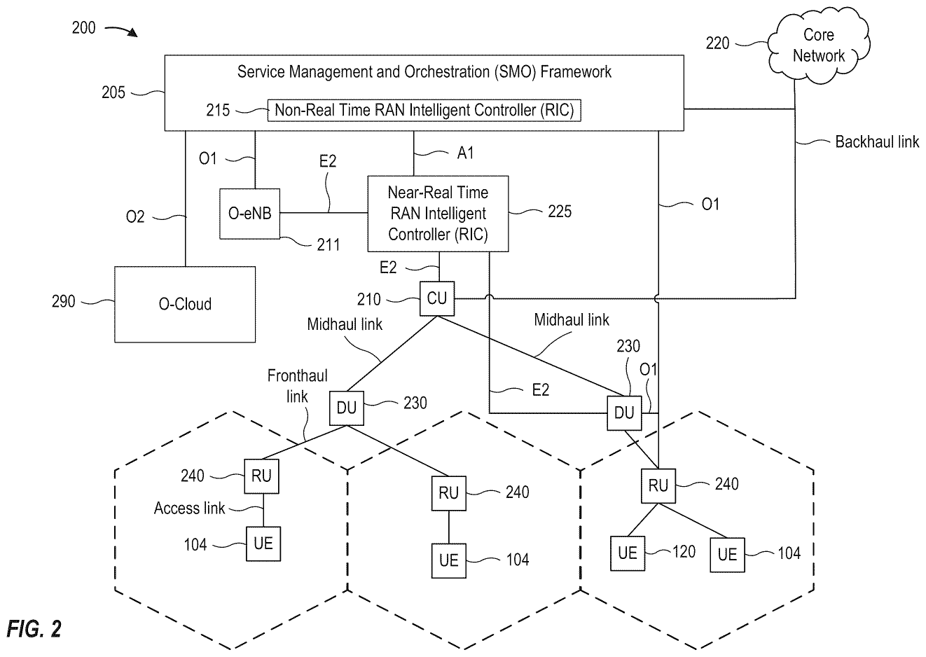

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR 2) as including 24,250 MHz-71,000 MHz, which is sometimes referred to (interchangeably) as a “millimeter wave” (“mmW” or “mmWave”). In some cases, FR2may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., BS 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

UE 104 includes an RO activation component 198, which may be used to obtain an activation indication and activate, based on the activation indication, a subset of ROs associated with one or more time periods, as further described herein. Further, BS 102 includes an RO activation component 199, which may be used to send an activation indication to trigger the activation of a subset of ROs associated with one or more time periods, as further described herein.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, PRACH extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

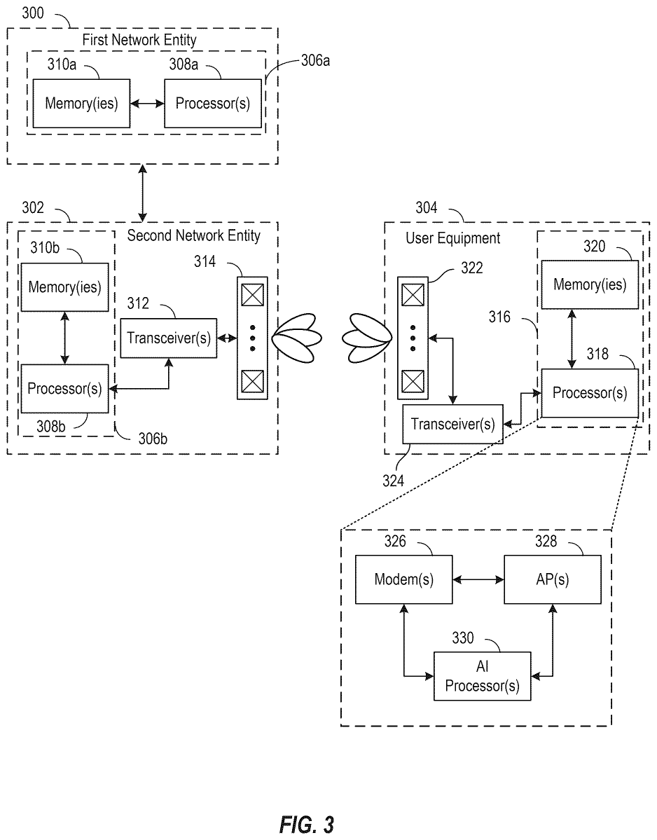

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

In certain aspects, the one or more processors 308b may include an RO activation component (not shown), such as the RO activation component 199 in FIG. 1, which may be used to send an activation indication to trigger the activation of a subset of ROs associated with one or more time periods, as further described herein.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

In certain aspects, the one or more processors 318b may include an RO activation component (not shown), such as the RO activation component 198 in FIG. 1, which may be used to obtain an activation indication and activate, based on the activation indication, a subset of ROs associated with one or more time periods, as further described herein.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

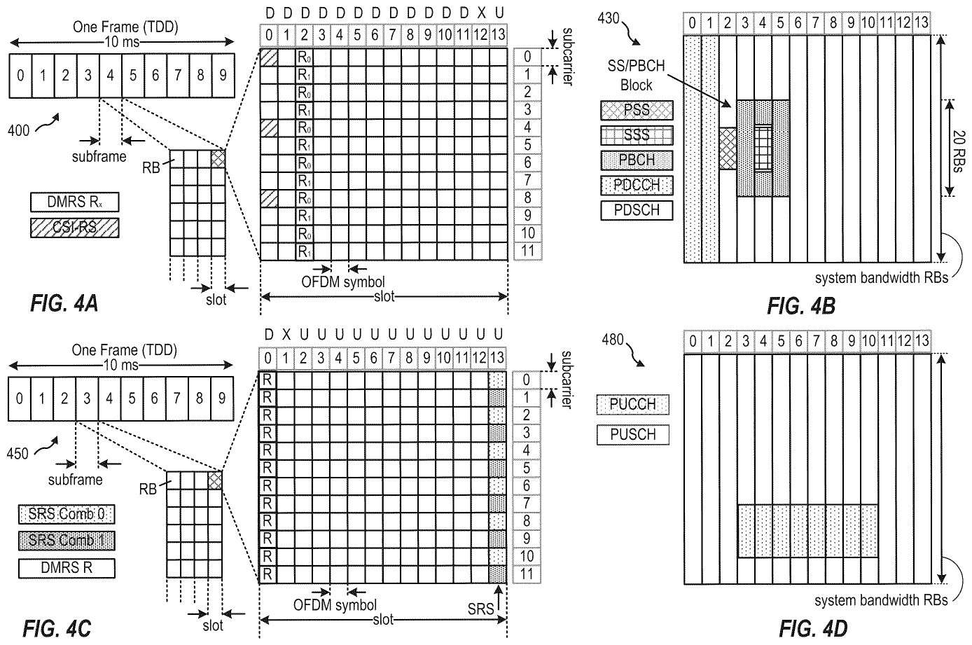

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Rach Procedures

Certain wireless communication systems (e.g., a 5G NR system and/or any future wireless communications system) may provide a specified channel for random access, such as a RACH, and corresponding random access procedures, also referred to herein as “RACH procedures.” A RACH procedure may be performed for any of various events including, for example, initial access from an idle state, RRC connection re-establishment, handover, downlink and/or uplink data arrival (e.g., when the UE is in an idle state), or device positioning.

As used herein, RRC states of a UE in a RAN include (1) a connected state (also referred to as a “connected mode,” “RRC connected mode,” and/or “RRC connected state”), (2) an inactive state (also referred to as an “inactive mode,” “RRC inactive mode,” and/or “RRC inactive state”), and (3) an idle state (also referred to as an “idle mode,” “RRC idle mode,” and/or “RRC idle state”). The UE may be operating in a connected state in the RAN after establishing an RRC connection with a network entity in the RAN. The UE may be operating in an idle state in the RAN when the UE is not connected, or in other words, does not have an established RRC connection with the network entity in the RAN. The UE may be operating in an inactive state in the RAN when the UE has an established RRC connection with the network entity in the RAN, but the connection is in a dormant, suspended, or inactive and there is no active communication between the UE and the network entity. For example, while operating in the inactive state, unlike the idle state, a non-access stratum (NAS) layer of an RRC connection established by the UE may continue to be connected.

FIG. 5A depicts a process flow diagram of an example RACH procedure 500a (referred to as a “four-step RACH procedure”) performed between a UE 504 and a network entity 502. In some aspects, the UE 504 is the UE 104 of FIG. 1 or the UE 304 of FIG. 3, and the network entity 502 is the BS 102 of FIG. 1, the first network entity 300 or the second network entity 302 of FIG. 3, or a disaggregated base station as discussed with respect to FIG. 2.

The RACH procedure 500a may begin, at 506, with the network entity 502 broadcasting and the UE 504 receiving an MIB. The MIB may be carried by the PBCH, which, as described above, may be logically grouped with a PSS and a SSS to form a SS/PBCH block, which, in some cases, may be referred to as an SSB. The MIB may be the first, among other SIBs, which may also be broadcasted by network entity 502. The MIB may be a control channel message sent by network entity 502 that provides information for UE 504 to synchronize with the network and access a cell of network entity 502. Network entity 502 may transmit MIBs periodically.

The RACH procedure 500a then proceeds, at 508, with the network entity 502 broadcasting and the UE 504 receiving a SIB1. The SIB1 may carry basic information that UE 504 may use to perform initial attachment to the RAN and network entity 502.

At 510, the UE 504 sends a first message (MSG1) to the network entity 502 on a PRACH. In some aspects, MSG1 may indicate or include a RACH preamble. The RACH preamble may indicate or include a preamble signature associated with the RACH preamble. The preamble signature may correspond to a particular preamble sequence (e.g., a Zaddoff Chu sequence) generated across time-frequency resources used for the preamble transmission. For contention-based random access (CBRA), the preamble sequence may be randomly selected among a set of preamble sequences (e.g., up to 64 sequences in some cases). The preamble signature may be used to identify the UE 504 for scheduling communications (e.g., MSG2 and MSG3) with the network entity 502. The term “RACH preamble” may refer to or correspond to “random access preamble,” “preamble,” “preamble sequence,” and/or “preamble signature.”

At 512, the network entity 502 responds with a random access response (RAR) message (MSG2). For example, in certain aspects, at 511, the network entity 502 may send a PDCCH communication including DCI that schedules the RAR on the PDSCH. The RAR message and the DCI that schedule the RAR are examples of a RAR-related message. The RAR may include, for example, certain parameters used for an uplink transmission such as a random access (RA) preamble identifier (RAPID), a timing advance, an uplink (UL) grant (e.g., indicating one or more time-frequency resources for an uplink transmission), cell radio network temporary identifier (C-RNTI), and/or a backoff parameter value. The RAPID may correspond to the preamble signature and indicate that the RAR is for the UE 504 that transmitted MSG1 at 510. As an example, the RAPID may identify a particular frequency resource used for the preamble transmission. The backoff parameter value may be used to determine an RO for sending a subsequent RACH transmission (e.g., a preamble transmission). An RO may correspond to one or more time-frequency resources available for transmitting a preamble on a RACH.

At 514, in response to MSG2, the UE 504 transmits a third message (MSG3) to the network entity 502 on the PUSCH. In some aspects, MSG3 may include an RRC connection request, a tracking area update (e.g., for UE mobility), and/or a scheduling request (e.g., for an UL transmission). As an example, MSG3 may use the time-frequency resource(s) indicated in the UL grant of the RAR. In some examples, MSG3 may include a bitmap of one or more requested SI messages.

At 516, the network entity 502 sends a contention resolution message (MSG4) in response to MSG3. In some cases, if the UE 504 is unable to receive or decode MSG3 and/or MSG4, the UE 504 may repeat RACH procedure 500a.

In some cases, to reduce the latency associated with random access, another RACH procedure may be used, such as a two-step RACH procedure instead of a four-step RACH procedure (e.g., RACH procedure 500a). As the name implies, the two-step RACH procedure may effectively consolidate the four messages of the four-step RACH procedure into two messages.

FIG. 5B depicts a process flow diagram of another example RACH procedure 500b (referred to as a “two-step RACH procedure”) performed between the UE 504 and the network entity 502. The RACH procedure 500b may optionally begin at 550, where the network entity 502 broadcasts and the UE 504 receives a MIB, for example within an SSB. Further, at 552, the network entity 502 broadcasts and the UE 504 receives a SIB1 (e.g., steps 550 and 552 in the RACH procedure 500b may be similar to steps 506 and 508 in the RACH procedure 500a). The SIB1 may include random access resources in SI-RequestConfig, where the RA resources are linked to requested SI messages.

At 554, the UE 504 sends a first message (MSG1 or MSGA) to the network entity 502, which may effectively combine MSG1 and MSG3 described above with respect to FIG. 5A. In some aspects, MSG1/MSGA includes a RACH preamble for random access and a payload. For example, the payload may include a UE-ID and other signaling information, such as a buffer status report and/or a scheduling request. The RACH preamble of MSG1/MSGA may be transmitted over the RACH, and the payload of MSGA may be transmitted over the PUSCH, for example.

At 556, the network entity 502 sends a random access response message (MSG2 or MSGB), which may effectively combine MSG2 and MSG4 described above with respect to FIG. 5A. For example, MSG2/MSGB may include a RAPID. For example, in certain aspects, at 555, the network entity 502 may send a PDCCH communication including DCI that schedules the RAR on the PDSCH. The RAR message and the DCI that schedule the RAR are examples of a RAR-related messages.

In certain aspects, UE 504 obtains, from network entity 502, a RACH configuration to perform RACH procedure 500a or RACH procedure 500b. The RACH configuration may identify ROs corresponding to time-frequency resources configured for random access communications, such as for the transmission of the first message (MSG1) to the network entity 502 in RACH procedure 500a or the transmission of the first message (MSG1 or MSGA) to the network entity 502 in RACH procedure 500b. The ROs may be fixed, meaning that they may not adjust to varying network conditions (e.g., always active ROs).

In certain other aspects, UE 504 obtains, from network entity 502, multiple RACH configurations to perform RACH procedure 500a or RACH procedure 500b. In certain aspects, the multiple RACH configurations may include a first RACH configuration and a second RACH configuration. The first RACH configuration may configure the UE with a first set of ROs, which may be fixed and used for random access communications, and the second RACH configuration (e.g., an additional RACH configuration) may configure the UE with a second set of ROs (e.g., additional RO(s)), which may be initially dormant and later activated (e.g., made available) for random access communications.

### Example DCI-based RO Activation

DCI-based adaptation is one example technique that may be used to activate RO(s) of a RACH configuration for random access communications, such as additional RO(s) of an additional RACH configuration. DCI-based adaptation may activate additional RO(s) of the additional RACH configuration to increase the opportunities available for a UE to initiate a RACH procedure and thus establish a connection with a network entity. For example, DCI-based adaptation may utilize DCI to dynamically adjust a RACH configuration by informing a UE about which RO(s) to activate. The UE may activate the indicated RO(s), based on receiving the DCI, such that these RO(s) (in some cases, in additional to legacy RO(s)) are available for use by the UE to initiate a RACH procedure.

In certain aspects, the DCI may include a “PRACH mask index” used to inform a UE about which ROs, (1) associated with a single SSB index or (2) per SSB index for multiple SSB indexes, to activate for random access signal transmission (e.g., preamble transmission) from the UE to the network entity. Different PRACH mask indexes may be associated with different RO(s) per SSB index (e.g., different PRACH mask indexes may be mapped to specific RO(s) per SSB index).

As an illustrative example, a first set of four ROs of a RACH configuration may be mapped to and associated with a first SSB index (SSB index 1), and a second set of four ROs of the RACH configuration may be mapped to and associated with a second SSB index (SSB index 2). Each RO of the first set of four ROs and each RO of the second set of four ROs may be associated with a unique RO index between 1-4. A first PRACH mask index (PRACH mask index 1) may be associated with a first RO, in time (corresponding to RO index 1), of each respective set of ROs (e.g., the first RO of the first set of ROs associated with SSB index 1 and the first RO of the second set of ROs associated with SSB index 2). Additionally, a second PRACH mask index (PRACH mask index 2) may be associated with every even RO (corresponding to RO indexes 2 and 4) of each respective set of ROs (e.g., the second and fourth ROs of the first set of ROs associated with SSB index 1 and the second and fourth ROs of the second set of ROs associated with SSB index 2).

In a first case, a DCI, sent to a UE, may include PRACH mask index 1. The DCI including PRACH max index 1 may indicate, to the UE, to activate the first RO of the first set of ROs associated with SSB index 1 and the first RO of the second set of ROs associated with SSB index 2 (while keeping other ROs deactivated/masked for random access communications).

In a second case, a DCI, sent to the UE, may include PRACH mask index 2. The DCI including PRACH mask index 2 may indicate, to the UE, to activate every even RO of the first and second sets of ROs, for example, the second and fourth ROs of the first set of ROs associated with SSB index 1 and the second and fourth ROs of the second set of ROs associated with SSB index 2 (while keeping other ROs deactivated/masked for random access communications).

Although aspects herein describe the use of PRACH mask indexes for DCI-based adaptation, in some other examples, PRACH mask indexes may be indicated via semi-static configuration (e.g., via a SIB1) and/or RRC configuration, and/or other configuration.

A technical problem associated with existing techniques for RO activation, including the use of PRACH mask indexes for RACH configuration adaptation, includes their inflexibility to activate a specific subset of ROs that are that are close together in time, and in some cases, where the subset of ROs repeats over time. Existing techniques for RO activation, which utilize PRACH mask indexes, may also be inflexible in activating subsets of ROs that correspond to time periods that are less than or greater than an RO index periodicity (e.g., ROs occurring during a first time period where the first time period is less than the RO index periodicity, ROs occurring during a second time period where the second time period is less than the RO index periodicity, etc.). Thus, using PRACH mask indexes to activate ROs with the same RO index, but associated with different SSB indexes, may allow for the activation of only limited sets of configured ROs.

### Aspects Related to Dynamic RO Activation for a Subset of ROs Associated with One or More Time Periods

Aspects described herein improve upon the state of the art by providing techniques for RACH configuration adaptation, and more specifically, triggering the activation of a subset of configured ROs for random access communications. The subset of ROs may correspond to time-frequency resources configured for random access communications, which are associated with (e.g., occurring during) one or more time periods. For example, in certain aspects, the subset of ROs may correspond to time-frequency resources that occur during association period(s), SSB mapping cycle(s), and/or association pattern period(s) for one or more RACH configurations. As another example, in certain aspects, the subset of ROs may correspond to time-frequency resources that occur during time period(s) associated with an indicated offset and time duration, and further, in some cases, an indicated periodicity.

In certain aspects, the subset of ROs may be associated with a plurality of SSB indexes, which are assigned to a plurality of SSBs. Further, in certain aspects, the subset of ROs may be associated with a plurality of SSB indexes that are assigned to a plurality of SSBs that may be transmitted to a UE, but includes less than all SSBs that may be transmitted to the UE. For example, the subset of ROs may include ROs associated with the first RO associated with each SSB index among SSB indexes 1-3, and may not include the first RO associated with SSB index 4 (e.g., where SSBs assigned SSB indexes 1-4 may be transmitted to the UE).

Various mechanisms, described herein, may be considered for activating the subset of ROs occurring during the one or more time periods. One or more of the mechanisms may be used to trigger the activation of a subset of ROs, thereby resulting in the activation of ROs that are close together in time. For example, the activated ROs may all occur close together in time, such as a during a first time period. As another example, a first subset of the activated ROs may all occur close together in time during a first time period, a second subset of the activated ROs may all occur close together in time during a second time period, and/or so on. The activation of ROs occurring close together in time may allow for increased network energy savings and improved network resource usage, as described herein. The various mechanisms used for activating such ROs may also provide for more flexibility in activation, such that the aforementioned technical advantages may be realized.

### Example Signaling for the Dynamic Activation of a Subset of ROs Associated with One or more Time Periods

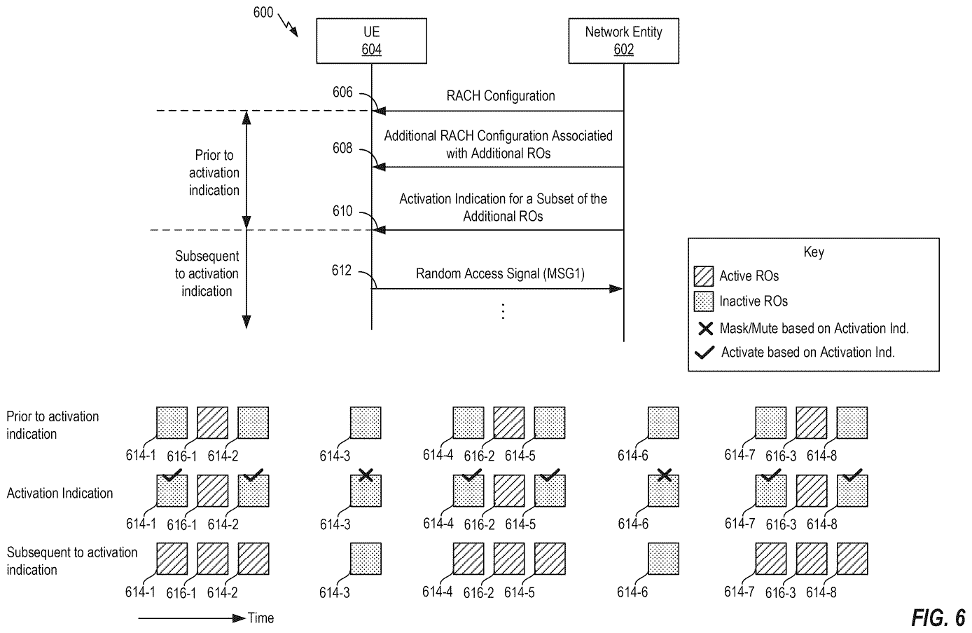

FIG. 6 depicts a process flow 600 for communications in a network between a network entity 602 and a UE 604 to dynamically activate a subset of ROs of a RACH configuration (e.g., such as an additional RACH configuration), where the subset of ROs are associated with one or more time periods. In certain aspects, the network entity 602 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 604 may be an example of UE 104 depicted and described with respect to FIG. 1 or the UE 304 depicted and described with respect to FIG. 3. However, in other aspects, UE 604 may be another type of wireless communications device and network entity 602 may be another type of network entity or network node, such as those described herein.

Process flow 600 begins, at 606, with network entity 602 sending, to UE 604, a RACH configuration. The RACH configuration may identify ROs that correspond to time-frequency resources configured for random access communication(s) (e.g., “ROs associated with the RACH configuration”). In certain aspects, the RACH configuration may be a legacy RACH configuration, where the ROs are fixed. For example, the ROs may remain active for random access communications and may not be adjusted (e.g., deactivated or re-activated) such as to account for varying network requirements.

As an illustrative example, the RACH configuration may be associated with ROs 616-1, 616-2, and 616-3 (individually referred to herein as “RO 616” and collectively referred to herein as “ROs 616”). As shown in FIG. 6, ROs 616 may be activated prior to an activation indication and may also remain active subsequent to the activation indication. UE 604 may use RO 616-1, RO 616-2, and/or RO 616-3 for sending a random access signal to initiate a RACH procedure (e.g., such as RACH procedure 500a of FIG. 5A or RACH procedure 500b of FIG. 5B) with network entity 602.

At 608, network entity 602 sends, to UE 604, an additional RACH configuration. The additional RACH configuration may be associated with the RACH configuration sent at 606. The additional RACH configuration may identify additional ROs (e.g., beyond the ROs of the RACH configuration sent at 606) that correspond to time-frequency resources configured for random access communications (e.g., “ROs associated with the additional RACH configuration”). In certain aspects, the additional RACH configuration may be sent to UE 604, by network entity 602, such as to accommodate varying network requirements. For example, the additional ROs configured by the additional RACH configuration in the time domain, may be activated and/or deactivated over time, such as in response to changing network traffic and/or access requests.

As an illustrative example, the additional RACH configuration may be associated with additional ROs 614-1 through 614-8 (individually referred to herein as “additional RO 614” and collectively referred to herein as “additional ROs 614”). As shown in FIG. 6, the additional ROs 614 may be deactivated when configured via the additional RACH configuration (e.g., shown as “prior to an activation indication being sent from network entity 602 to UE 604”). At a later time, such as after an activation indication, a subset of the additional ROs may be activated.

Specifically, in certain aspects, an activation indication may be sent to activate (e.g., trigger the activation of) a subset (e.g., one or more) of the additional ROs. The subset of the additional ROs may be associated with one or more time periods. The subset of the additional ROs may be associated with multiple SSB indexes that are associated with multiple SSBs, as in a plurality of SSBs.

For example, at 610, network entity 602 sends, to UE 604, an activation indication. The activation indication may be sent to UE 604 to trigger UE 604 to activate a subset of the additional ROs 614 (e.g., configured via the additional RACH configuration sent at 608). In this example, the activation indication may indicate to activate ROs 614-1, 614-2, 614-4, 614-5, 614-7, and 614-8. Additional ROs 614-1 and 614-2 may be associated with a first time period, additional ROs 614-4 and 614-5 may be associated with a second time period, and additional ROs 614-7 and 614-8 may be associated with a third time period (e.g., time periods are not shown in FIG. 6). The activation indication may not indicate to activate additional RO 614-3 or additional RO 614-6. For example, the activation indication may indicate to mask or mute additional ROs 614-3 and 614-6. Thus, subsequent to the activation indication, ROs 616-1, 616-2, and 616-3 (e.g., part of the RACH configuration) and additional ROs 614-1, 614-2, 614-4, 614-5, 614-7, and 614-8 (e.g., part of the additional RACH configuration) may be activated. UE 604 may use ROs 616-1, 616-2, and 616-3 and/or additional ROs 614-1, 614-2, 614-4, 614-5, 614-7, and 614-8 for sending a random access signal to initiate a RACH procedure with network entity 602.

Based on the activation indication indicating to activate a subset of the additional ROs that are associated with three time periods, and not activating additional ROs 614-3 and 614-6, which do not belong to one of these time periods, network entity 602 may enter into a lower-power state between (1) additional RO 614-2 and additional RO 614-4 and (2) between additional RO 614-5 and additional RO 614-7. This may allow for increased network energy savings and improved network resource usage at network entity 602.

At 612, UE 604 sends, to network entity 602, a random access signal (e.g., such as MSG1 shown in RACH procedure 500a of FIG. 5A or MSGA/MSG1 shown in RACH procedure 500b of FIG. 5B). UE 604 may send the random access signal to initiate a RACH procedure with network entity 602. UE 604 may send the random access signal in an RO of the subset of ROs that are activated via the activation indication (e.g., received by UE 604). For example, although not shown in FIG. 6, UE 604 may use additional RO 614-4 for sending a random access signal (e.g., a preamble) to network entity 602 to indicate a RACH procedure.

Note that the process flow 600 illustrated in FIG. 6 is described herein to facilitate an understanding of dynamic RO activation for a subset of ROs, and aspects of the present disclosure may be performed in various manners via alternative or additional signaling and/or operations. In certain aspects, the operations and/or signaling of FIG. 6 may occur in an order different from that described or depicted, and various actions, operations, and/or signaling may be added, omitted, or combined.

Additionally, although FIG. 6 illustrates the activation of a subset of additional ROs that are configured via an additional RACH configuration, in certain other examples, a similar activation indication may be used to activate or deactivate (e.g., mask or mute) a subset of ROs that are configured via a RACH configuration, which may not be an “additional RACH configuration.”

As described herein, one or more time periods associated with a subset of ROs, which may be activated via an activation indication (e.g., such as the activation indication sent at 608 in FIG. 6), may include (1) association period(s) of a RACH configuration (e.g., such as the additional RACH configuration sent to UE 604 in FIG. 6), (2) SSB mapping cycle(s) of a RACH configuration, (3) association pattern period(s) of a RACH configuration, and/or (4) one or more time durations associated with a start time and a length of time (e.g., and, in some cases, associated with a periodicity, such that they repeat) that occur during a RACH configuration time period associated with a RACH configuration that configures RO(s) during the RACH configuration time period.

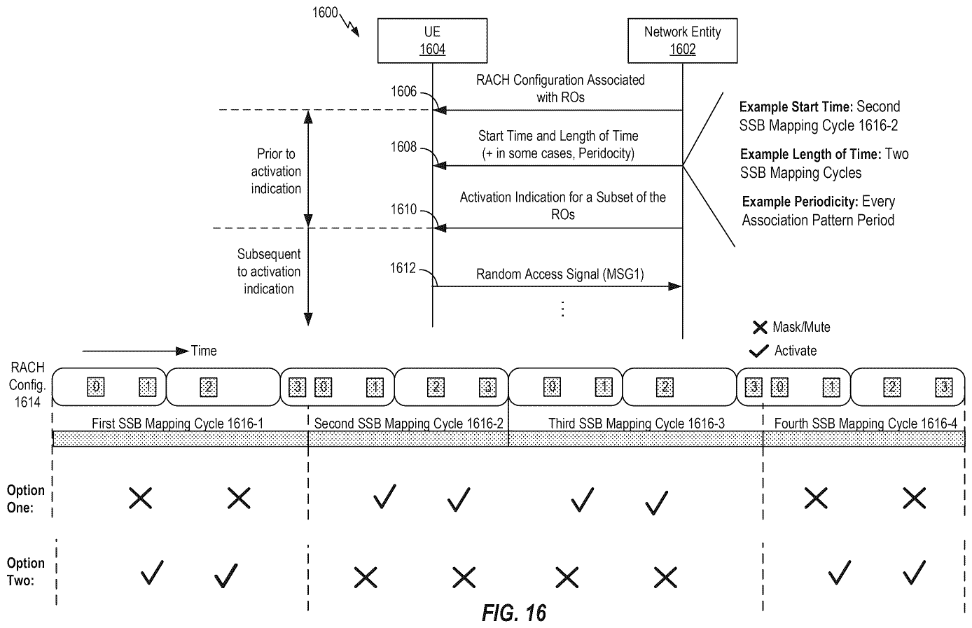

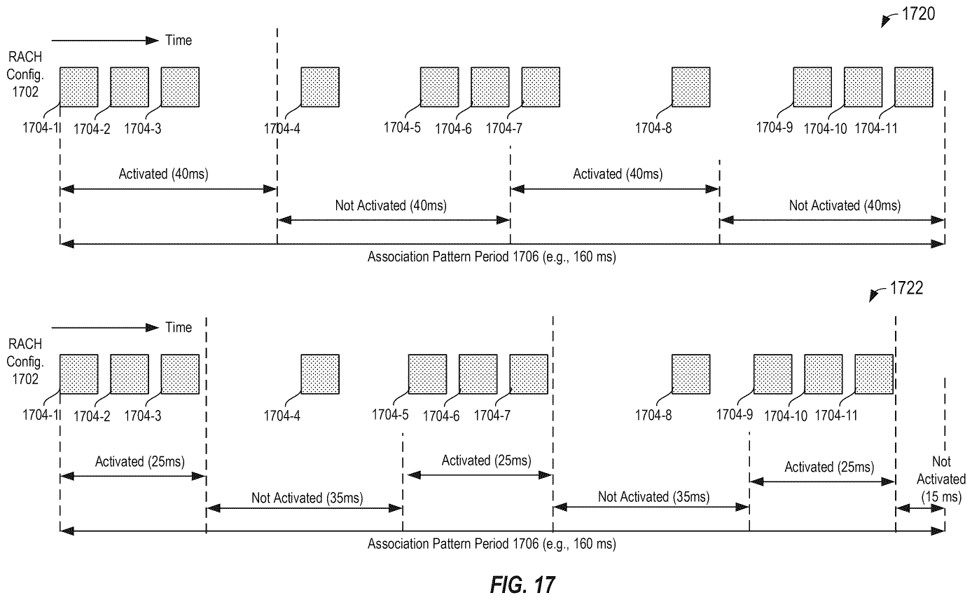

Aspects related to activating a subset of ROs associated with one or more association periods, one or more SSB mapping cycles, and/or one or more association pattern periods are provided below with respect to FIGS. 7-11. Aspects related to activating a subset of ROs associated with one or more time durations associated with a start time and a length of time are provided below with respect to FIGS. 16 and 17.

As previously described, an “association period” of a RACH configuration may refer to a time period of the smallest integer of {1,2,4,8,16} RACH configuration periods that include ROs associated with at least one instance of every SSB index. A “RACH configuration period” may refer to a time interval for which ROs are available for use by one or more UEs to access the network. An “SSB mapping cycle” of a RACH configuration may refer to a time interval that includes ROs associated with SSB indexes that are associated with/assigned to every SSB that may be transmitted to the UE. Further, an “association pattern period” of a RACH configuration may refer to a pattern of association periods, of the RACH configuration, over a period of 160 ms.

FIG. 7 depicts example time periods, such as example association periods, example SSB mapping cycles, and an association pattern period, associated with an example RACH configuration 700. As shown in FIG. 7, example RACH configuration 700 may be associated with ROs 702-1 through 702-16 (individually referred to herein as “RO 702” and collectively referred to herein as “ROs 702”) corresponding to time-frequency resources that are configured for random access communications.

Each RO 702 may be associated with an SSB index between 0 and 3. For example, RO 702-1 may be associated with SSB index 0, such that RO 702-1 corresponds to time-frequency resource(s) for communicating random access communications (e.g., a preamble of a RACH procedure) associated with a transmission, to the UE, of an SSB associated with SSB index 0. Specifically, a UE may receive an SSB associated with SSB index 0, measure the SSB to determine a preferred beam to use for communication, and then send, in an RO of the first set of ROs, a preamble indicating the preferred beam. As another example, RO 702-4 may be associated with SSB index 3, such that RO 702-4 corresponds to time-frequency resource(s) for communicating random access communications (e.g., a preamble of a RACH procedure) associated with a transmission, to the UE, of an SSB associated with SSB index 3. Specifically, a UE may receive an SSB associated with SSB index 3, measure the SSB to determine a preferred beam to use for communication, and then send, in an RO of the first set of ROs, a preamble indicating the preferred beam. The ROs 702 of example RACH configuration 700, which are associated with different SSB indexes, may repeat in a pattern for the RACH configuration 700 (e.g., where the pattern includes an RO 702 associated with SSB index 0, an RO 702 associated with SSB index 1, an RO 702 associated with SSB index 2, and an RO 702 associated with SSB index 3). The pattern of ROs may have refer to an RO periodicity of the ROs.

As shown in FIG. 7, example RACH configuration 700 may include four SSB mapping cycles, including first SSB mapping cycle 706-1, second SSB mapping cycle 706-2, third SSB mapping cycle 706-3, and fourth SSB mapping cycle 706-4 (individually referred to herein as “SSB mapping cycle 706” and collectively referred to herein as “SSB mapping cycles 706”). Each SSB mapping cycle 706 may be a time interval that includes ROs associated with every SSB index, such as four ROs 702 associated with SSB indexes 0-3.

Further, as shown in FIG. 7, example RACH configuration 700 may include two association periods, including first association period 708-1 and second association period 708-2 (individually referred to herein as “association period 708” and collectively referred to herein as “association periods 708”). Each association period 708 may be a time interval of four RACH configuration periods 704 that include ROs 702 associated with at least one instance of each of SSB indexes 0, 1, 2, and 3 (e.g., at least one instance of every SSB index). For example, first association period 708-1 includes four RACH configuration periods 704, as well as at least one RO 702 associated with SSB index 0, at least one RO 702 associated with SSB index 1, at least one RO 702 associated with SSB index 2, and at least one RO 702 associated with SSB index 3.

Further, as shown in FIG. 7, example RACH configuration 700 may include one association pattern period 710. Association pattern period 710 may include two association periods 708 (e.g., first association period 708-1 and second association period 708-2), which occur over 160 ms.

It is noted that FIG. 7 depicts only example association periods, example SSB mapping cycles, and an example association pattern period that may be associated with a RACH configuration, and various other example time periods associated with a RACH configuration may be considered.

Various mechanisms may be used to activate a subset of ROs, of a RACH configuration, associated with one or more time periods, where the time period(s) include association period(s), SSB mapping cycle(s), and/or association pattern period(s).

For example, in certain aspects, an activation indication may be sent from a UE to a network entity to trigger the UE to activate the subset of ROs. The activation indication may comprise an RO subset mask index (e.g., an “index”) associated with a pattern of periods (e.g., every odd period, two consecutive periods, etc.) for a single period type (e.g., association period, SSB mapping cycle, etc.).

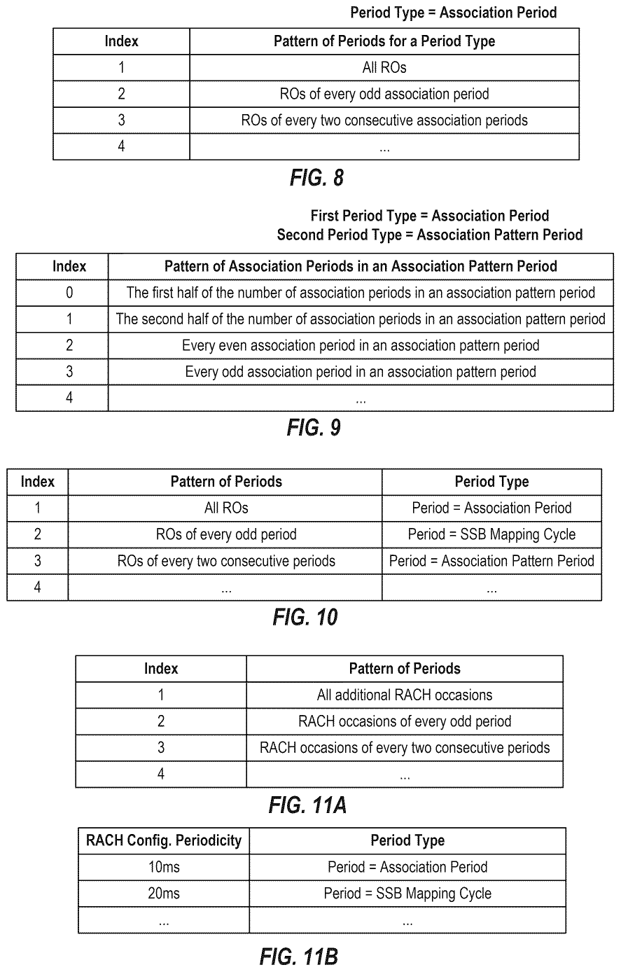

FIG. 8 depicts example associations between RO subset mask indexes and patterns of periods for a given period type. In FIG. 8, the given period may comprise “association periods.” Thus, the RO subset mask indexes, shown in FIG. 8, may be used to activate and/or deactivate ROs belonging to specific association periods. The RO subset mask indexes, shown in FIG. 8, may not be used to activate and/or deactivate ROs belonging to specific SSB mapping cycles and/or association pattern periods. However, in some other examples, the given period type may comprise “SSB mapping cycles” or “association pattern periods” such that the RO subset mask indexes are used to activate and/or deactivate ROs belonging to these specific time periods.

As an illustrative example, an activation indication, sent from a network entity to a UE (e.g., such as sent from network entity 602 to UE 604 in FIG. 6), may comprise an RO subset mask index=2. As shown in FIG. 8, an RO subset mask index=2 may be associated with the activation of ROs of every odd association period (e.g., ROs corresponding to time-frequency resources that occur during every odd association period) for a RACH configuration. Thus, by including the RO subset mask index=2 in the activation indication, the UE may be triggered to activate ROs of every odd association period (e.g., a first association period, a third association period, a fifth association period, etc.) for the RACH configuration. The remaining ROs of the RACH configuration may be (or may remain) deactivated (e.g., masked or muted).

In certain other aspects, the activation indication (e.g., sent from a UE to a network entity to trigger the UE to activate a subset of ROs of a RACH configuration) may comprise an indication of an RO subset mask index (e.g., an “index”) associated with a pattern of a first given period type for a (larger) second given period type (e.g., association pattern period, etc.). “A pattern of a first given period type for a second given period type” may refer to “a pattern of a first given period type in a second given period type.”

FIG. 9 depicts example associations between RO subset mask indexes and patterns of a first given period type in a second given period type. For example, in FIG. 9, the first given period type may be “association period” and the second given period type may be “association pattern period.” Thus, the ROs belonging to a specific pattern of association periods in an association pattern period (or multiple association pattern periods, such as a pattern of association pattern periods) may be activated using an activation indication. For example, an activation indication, sent from a network entity to a UE (e.g., such as sent from network entity 602 to UE 604 in FIG. 6), may comprise an RO subset mask index=0. As shown in FIG. 9, an RO subset mask index=0 may be associated with the activation of ROs of every association period in the first half of the association periods in an association pattern period.

In certain other aspects, the activation indication (e.g., sent from a UE to a network entity to trigger the UE to activate a subset of ROs of a RACH configuration) may comprise an indication of an RO subset mask index (e.g., an “index”) associated with a pattern of periods (e.g., every odd period, two consecutive periods, etc.) and a period type (e.g., association period, SSB mapping cycle, etc.). FIG. 10 depicts example associations between RO subset mask indexes and patterns of periods for various period types.

As an illustrative example, an activation indication, sent from a network entity to a UE (e.g., such as sent from network entity 602 to UE 604 in FIG. 6), may include RO subset mask index=2. As shown in FIG. 10, the RO subset mask index=2 may be associated with (1) ROs of every odd period of a RACH configuration (2) where the period corresponds to a period type of SSB mapping cycle. Thus, by including the RO subset mask index=2 in the activation indication, the UE may be triggered to activate ROs of every odd SSB mapping cycle (e.g., a first SSB mapping cycle, a third SSB mapping cycle, a fifth SSB mapping cycle, etc.) of the RACH configuration. The remaining ROs of the RACH configuration may be (or may remain) deactivated (e.g., masked or muted).

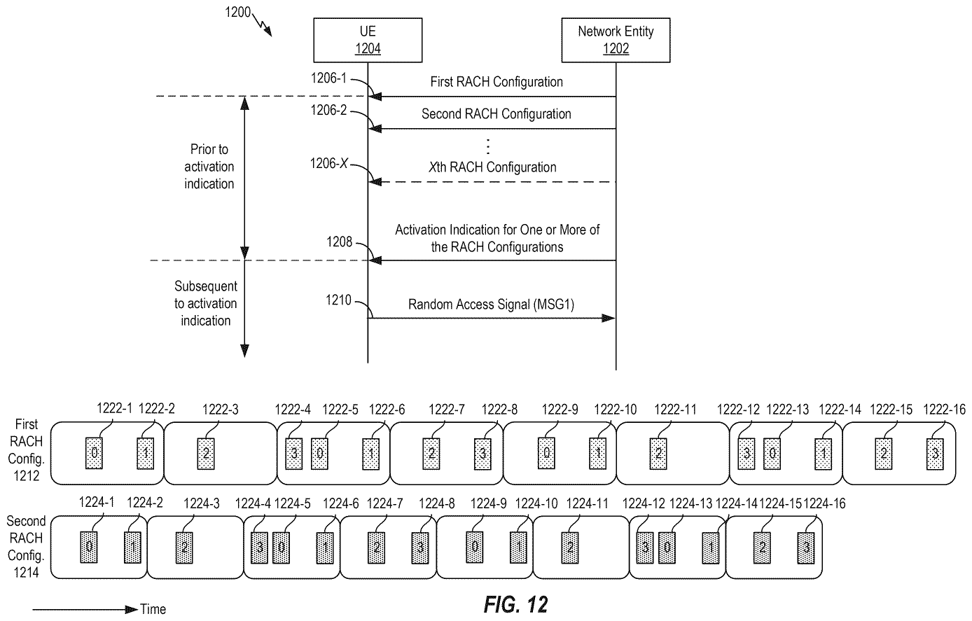

In certain other aspects, the activation indication (e.g., sent from a UE to a network entity to trigger the UE to activate a subset of ROs of a RACH configuration) may comprise an indication of an RO subset mask index (e.g., an “index”) associated with only a pattern of periods (e.g., every odd period, two consecutive periods, etc.). FIG. 11A depicts example associations between RO subset mask indexes and patterns of periods. Different than FIG. 10, in FIG. 11A, each RO subset mask index is only associated with a specific pattern of periods and not also a specific period type. In certain aspects, the UE may obtain another indication of the period type.

As an illustrative example, an activation indication, sent from a network entity to a UE (e.g., such as sent from network entity 602 to UE 604 in FIG. 6), may include RO subset mask index=2. As shown in FIG. 11A, the RO subset mask index=2 may be associated with ROs of every odd period of a RACH configuration. In this example, the UE may also obtain an indication that the period type comprises SSB mapping cycles. Thus, by including the RO subset mask index=2 in the activation indication and receiving an indication of the period type=SSB mapping cycles, the UE may be triggered to activate ROs of every odd SSB mapping cycle (e.g., a first SSB mapping cycle, a third SSB mapping cycle, a fifth SSB mapping cycle, etc.) of the RACH configuration. The remaining ROs of the RACH configuration may be (or may remain) deactivated (e.g., masked or muted).

In certain other aspects, the activation indication (e.g., sent from a UE to a network entity to trigger the UE to activate a subset of ROs of a RACH configuration) may comprise an indication of an RO subset mask index (e.g., an “index”) associated with only a pattern of periods (e.g., every odd period, two consecutive periods, etc.). Further, the UE may determine the period type based on a RACH configuration periodicity of the RACH configuration. For example, different RACH configuration periodicities may be associated with different period types. FIG. 11B depicts example associations between RACH configuration periodicities and period types. In certain aspects, the UE may obtain an indication of at least the period type that is associated with the RACH configuration periodicity of the RACH configuration. In certain aspects, the period type that is associated with the RACH configuration periodicity of the RACH configuration may be defined in wireless specification standards, such as 3GPP specifications.

As an illustrative example, an activation indication, sent from a network entity to a UE (e.g., such as sent from network entity 602 to UE 604 in FIG. 6), may comprise an RO subset mask index=2. As shown in FIG. 11A, the RO subset mask index=2 may be associated with ROs of every odd period of a RACH configuration. The RACH configuration may have a RACH configuration periodicity of 20 ms. In this example, the UE may also obtain an indication that the RACH configuration periodicity of 20 ms is associated with a period type=SSB mapping cycles. Thus, by including the RO subset mask index=2 in the activation indication and receiving an indication of the association between RACH configuration periodicity of 20 ms and a period type of SSB mapping cycles, the UE may be triggered to activate ROs of every odd SSB mapping cycle (e.g., a first SSB mapping cycle, a third SSB mapping cycle, a fifth SSB mapping cycle, etc.) of the RACH configuration. The remaining ROs of the RACH configuration may be (or may remain) deactivated (e.g., masked or muted).

FIG. 12 depicts a process a flow 1200 for communications in a network between a network entity 1202 and a UE 1204 to dynamically activate a subset of ROs of one or more RACH configurations, where the subset of ROs are associated with one or more times periods. In certain aspects, the network entity 1202 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1204 may be an example of UE 104 depicted and described with respect to FIG. 1 or the UE 304 depicted and described with respect to FIG. 3. However, in other aspects, UE 1204 may be another type of wireless communications device and network entity 1202 may be another type of network entity or network node, such as those described herein. Note that any operations or signaling illustrated with dashed lines may indicate that that operation or signaling is an optional or alternative example.

Different from process flow 600 of FIG. 6, in process flow 1200 of FIG. 12, UE 604 may be configured with multiple RACH configurations. Thus, in some cases, an activation indication, sent from network entity 1202 to UE 1204, may indicate to activate a subset of ROs associated with a single RACH configuration of the multiple RACH configuration (e.g., where the subset of ROs are associated with one or more time periods). In some other cases, however, an activation indication, sent from network entity 1202 to UE 1204, may indicate to activate a subset of ROs associated with two or more RACH configurations of the multiple RACH configurations (e.g., where the subset of ROs are associated with one or more time periods).

For example, as shown in FIG. 12, process flow 1200 begins, at 1206-1, with network entity 1202 sending, to UE 1204, a first RACH configuration. The first RACH configuration may identify first ROs that correspond to first time-frequency resources configured for random access communication(s) (e.g., “first ROs associated with the first RACH configuration”). In certain aspects, the first RACH configuration may be an additional RACH configuration, such that the first ROs, associated with the first RACH configuration, are capable of being activated and/or deactivated over time.

At 1206-2, network entity 1202 sends, to UE 1204, a second RACH configuration. The second RACH configuration may identify second ROs that correspond to second time-frequency resources configured for random access communication(s) (e.g., “second ROs associated with the second RACH configuration”). The second ROs of the second RACH configuration may be different than the first ROs of the first RACH configuration. In certain aspects, the second RACH configuration may be another additional RACH configuration, such that the second ROs, associated with the second RACH configuration, are capable of being activated and/or deactivated over time.

In certain aspects, beyond the first and second RACH configurations, network entity 1202 may send, to UE 1204, one or more additional RACH configurations that configure ROs for the UE 1204, such as up to an Xth RACH configuration sent at 1206-X (where X is an integer greater than one).

The illustrative example shown in FIG. 12 depicts two RACH configurations, e.g., first RACH configuration 1212 and second RACH configuration 1214, which may be sent to UE 1204, from network entity 1202, at 1206-1 and 1206-2, respectively.

The first RACH configuration 1212 may be associated with first ROs 1222-1 through 1222-16 (individually referred to herein as “RO 1222” and collectively referred to herein as “ROs 1222”). In certain aspects, the ROs 1222 may be deactivated when configured, at UE 1204, via the first RACH configuration (e.g., shown as “prior to activation indication”). At a later time, such as after an activation indication (e.g., shown as “subsequent to activation indication), a subset of the first ROs may be activated or none of the first ROs may be activated.

The second RACH configuration 1214 may be associated with second ROs 1224-1 through 1224-16 (individually referred to herein as “RO 1224” and collectively referred to herein as “ROs 1224”). In certain aspects, the ROs 1224 may be deactivated when configured, at UE 1204, via the second RACH configuration (e.g., shown as “prior to activation indication”). At a later time, such as after an activation indication (e.g., shown as “subsequent to activation indication), a subset of the second ROs may be activated or none of the first ROs may be activated.

At 1208, network entity 1202 sends, to UE 1204, an activation indication. The activation indication may be sent to UE 1204 to trigger UE 1204 to activate a subset of ROs associated with one or more time periods, and for one or more of the RACH configurations.

In certain aspects, where UE 1204 is configured with multiple RACH configurations (e.g., such as multiple additional RACH configurations), the activation indication may activate a subset of ROs for each RACH configuration. Put differently, the activation indication may apply to all of the RACH configurations.

In some cases, the activation indication may be applied equally to all RACH configurations. For example, a UE may be configured with two RACH configurations. The UE may receive an activation indication indicating to activate a subset of ROs associated with one or more time periods, such as one or more association periods. In this example, the activation indication may trigger the activation of (1) ROs that correspond to time-frequency resources associated with the association period(s) of the first RACH configuration and (2) ROs that correspond to time-frequency resources associated with the association period(s) of the first RACH configuration. The association period(s) of the first RACH configuration may be different than the association period(s) of the second RACH configuration, such that the ROs that are activated, based on the activation indication, do not align in time.

In some other cases, the activation indication may be applied to a subset of ROs associated with time period(s) of a reference RACH configuration (e.g., one of the multiple RACH configurations), and then copied to the remaining configurations.

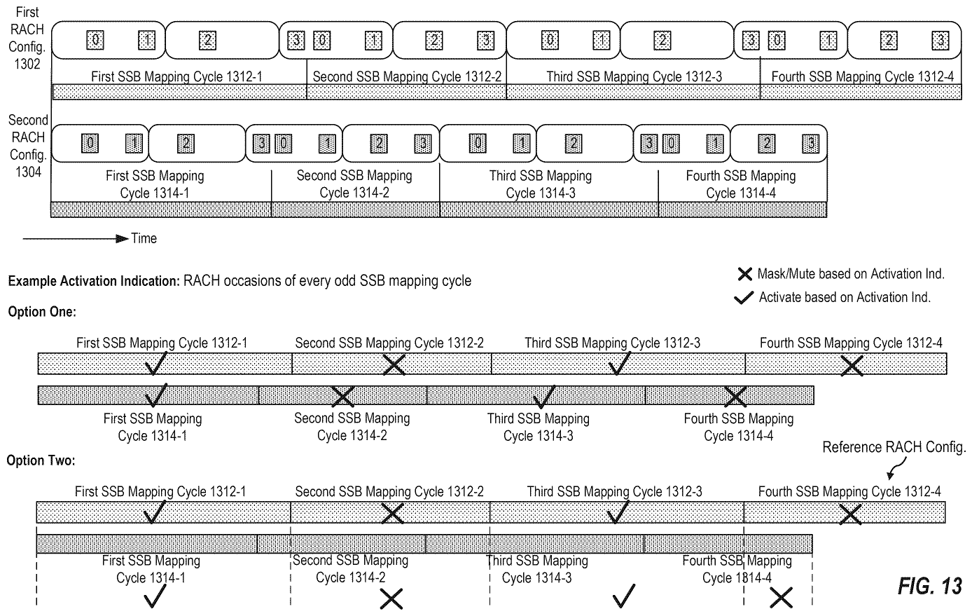

FIG. 13 depicts example activation of a subset of ROs of one or more RACH configurations, such as to illustrate the two cases described above. As shown in FIG. 13, an example first RACH configuration 1302 may be associated with four SSB mapping cycles, including a first SSB mapping cycle 1312-1, a second SSB mapping cycle 1312-2, a third SSB mapping cycle 1312-3, and a fourth SSB mapping cycle 1312-4 (collectively referred to herein as “SSB mapping cycles 1312” and individually referred to herein as “SSB mapping cycle 1312”). An example second RACH configuration 1304 may also be associated with four SSB mapping cycles, including a first SSB mapping cycle 1314-1, a second SSB mapping cycle 1314-2, a third SSD mapping cycle 1314-3, and a fourth SSB mapping cycle 1314-4 (collectively referred to herein as “SSB mapping cycles 1314” and individually referred to herein as “SSB mapping cycle 1314”). SSB mapping cycles 1312 may be different than SSB mapping cycles 1314. For example, boundaries of each SSB mapping cycle 1312 may not align with boundaries of each SSB mapping cycle 1314. As another example, time durations of each SSB mapping cycle 1312 may be different than time durations of each SSB mapping cycle 1314.

A UE (not shown in FIG. 13) may be configured with both first RACH configuration 1302 and second RACH configuration 1304. The UE may also receive an activation indication indicating to activate a subset of ROs associated with every odd SSB mapping cycle (e.g., the activation indication may include the RO subset index=2, as shown in FIG. 8). In certain aspects, the activation indication may apply to all RACH configurations obtained by the UE, such that ROs are activated for first RACH configuration 1302 and for second RACH configuration 1304.

In some cases (shown as “Option One” in FIG. 13), the activation indication activates ROs (e.g., all ROs) of every odd SSB mapping cycle 1312 of first RACH configuration 1302 and ROs (e.g., all ROs) of every odd SSB mapping cycle 1314 of second RACH configuration 1304. For example, as shown in “Option One,” ROs of first SSB mapping cycle 1312-1 and third SSB mapping cycle 1312-3 may be activated. Further, ROs of SSB mapping cycle 1314-1 and third SSB mapping cycle 1314-3 may be activated. One or more of the ROs that are activated across the two RACH configurations, based on the activation indication, may not align in time, at least in this example.

In some other cases (shown as “Option Two” in FIG. 13), the activation indication activates ROs of every odd SSB mapping cycle 1312 of first RACH configuration 1302. The first RACH configuration may comprise a reference RACH configuration. For example, as shown in “Option Two,” ROs of first SSB mapping cycle 1312-1 and third SSB mapping cycle 1312-3 may be activated. Further, the activation of the ROs of first SSB mapping cycle 1312-1 and third SSB mapping cycle 1312-3, for first RACH configuration 1302 (e.g., the reference RACH configuration), may be copied to second RACH configuration 1304. For example, all ROs of the second RACH configuration 1304 that align in time with first SSB mapping cycle 1312-1 and third SSB mapping cycle 1312-3 may be activated. Thus, the ROs that are activated across the two RACH configuration, based on the activation indication, may align in time.

In certain other aspects, where UE 1204 is configured with multiple RACH configurations (e.g., such as multiple additional RACH configurations), the activation indication may activate a subset of ROs for each RACH configuration of a subset of the multiple RACH configurations. For example, the activation indication may apply to only the subset of the multiple RACH configurations.

In some cases, the subset of the multiple RACH configurations may be determined based on an RRC mode of the UE. As used herein “RRC mode” and “RRC state” may be used interchangeably. As described in detail above an RRC mode of a UE may include a connected mode (also referred to as a “connected state,” “RRC connected mode,” and/or “RRC connected state”), (2) an inactive mode (also referred to as an “inactive state,” “RRC inactive mode,” and/or “RRC inactive state”), and (3) an idle mode (also referred to as an “idle mode,” “RRC idle mode,” and/or “RRC idle state”).

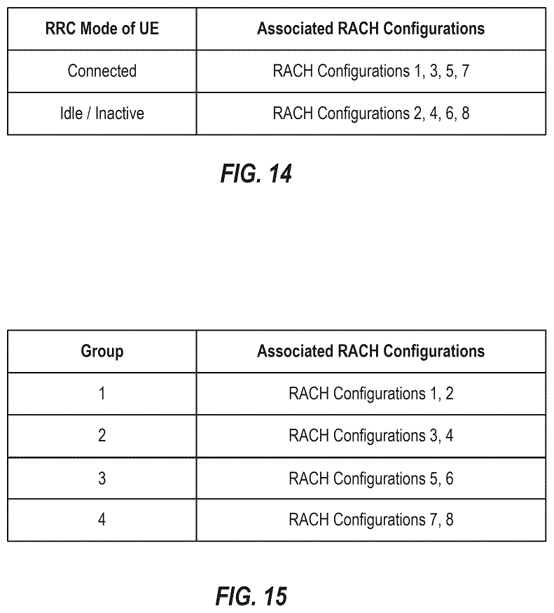

For example, different RACH configurations may be associated with different RRC modes of the UE. FIG. 14 depicts example associations between RRC modes of a UE and different RACH configurations. In certain aspects, the UE may obtain an indication of the RACH configuration(s) that are associated with an RRC mode of the UE (and/or other potential RRC modes of the UE).

In some cases, the subset of the multiple RACH configurations is determined based on a group index indicated to the UE. For example, different RACH configurations may be associated with different groups that are assigned unique group indexes. FIG. 15 depicts example groups of RACH configurations, which are assigned unique group indexes. For example, the UE may obtain an indication of group 1 and determine that the activation indication should apply to RACH configurations 1 and 2.

In some cases, the subset of the multiple RACH configurations is determined based on a semi-static configuration.

In certain aspects, where UE 1204 is configured with multiple RACH configurations (e.g., such as multiple additional RACH configurations), the activation indication may activate a subset of ROs for an indicated RACH configuration of the multiple RACH configurations. In certain aspects, the indicated RACH configuration may be indicated to the UE based on the activation indication. That is, the activation indication may be associated with one of the multiple RACH configurations. In certain aspects, the activation indication may comprise an RO subset mask index that is associated with one of the multiple RACH configurations, for which the activation indication is expected to apply.

Returning to FIG. 12, at 1210, UE 1204 sends, to network entity 1202, a random access signal (e.g., such as MSG1 shown in RACH procedure 500a of FIG. 5A or MSGA/MSG1 shown in RACH procedure 500b of FIG. 5B). UE 1204 may send the random access signal to initiate a RACH procedure with network entity 1202. UE 1204 may send the random access signal in an RO of the subset of ROs that are activated via the activation indication (e.g., received by UE 1204).

Note that the process flow 1200 illustrated in FIG. 12 is described herein to facilitate an understanding of dynamic RO activation for a subset of ROs, and aspects of the present disclosure may be performed in various manners via alternative or additional signaling and/or operations. In certain aspects, the operations and/or signaling of FIG. 12 may occur in an order different from that described or depicted, and various actions, operations, and/or signaling may be added, omitted, or combined.

FIG. 16 depicts a process flow 1600 for communications in a network between a network entity 1602 and a UE 1604 to dynamically activate a subset of ROs of a RACH configuration (e.g., such as an additional RACH configuration), where the subset of ROs are associated with one or more time periods. In certain aspects, the network entity 1602 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1604 may be an example of UE 104 depicted and described with respect to FIG. 1 or the UE 304 depicted and described with respect to FIG. 3. However, in other aspects, UE 1604 may be another type of wireless communications device and network entity 1602 may be another type of network entity or network node, such as those described herein.

As described herein, in certain aspects, the activation of a subset of ROs associated with one or more time periods may involve the activation of a subset of ROs associated with a start time and a length of time. The activation of such ROs is depicted and described with respect to process flow 1600.

For example, process flow 1600 begins, at 1606, with network entity 1602 sending, to UE 1604, a RACH configuration. The RACH configuration may identify ROs that correspond to time-frequency resources configured for random access communication(s) (e.g., “ROs associated with the RACH configuration”). In certain aspects, the RACH configuration may be an additional RACH configuration, such that the first ROs, associated with the first RACH configuration, may be activated and/or deactivated over time.

The illustrative example shown in FIG. 16 depicts an example RACH configuration 1614, which may be sent to UE 1604, from network entity 1602, at 1606. The RACH configuration 1614 may be associated with four SSB mapping cycles, such as first SSB mapping cycle 1616-1, second SSB mapping cycle 1616-2, third SSB mapping cycle 1616-3, and fourth SSB mapping cycle 1616-4 (individually referred to herein as “SSB mapping cycle 1616” and collectively referred to herein as “SSB mapping cycles 1616”). In certain aspects, the ROs corresponding to the four SSB mapping cycles 1616 of example RACH configuration 1614 may be deactivated at the time when UE 1604 is configured with example RACH configuration 1614.

At 1608, network entity 1602 sends, to UE 1604, an indication of a start time and a length of time that is associated with one or more time periods. In this example, the start time may comprise the second SSB mapping cycle 1616-2 of RACH configuration 1614. Further, the length of time may comprise two SSB mapping cycles. In some cases, UE 1604 may further obtain an indication of periodicity for the one or more time periods. In this example, the periodicity may comprise every association pattern period. In some cases, the periodicity may be a random periodicity, such as in ms.

Although in this example, the start time is indicated as the start of a cycle (e.g., such as the start of an SSB mapping cycle), in some other examples, the start time may be indicated as any arbitrary time, such as a start time that is defined by an offset in ms. Further, in some other examples, the start time may be indicated as an absolute time, such as a time in ms.

At 1610, network entity 1602 sends, to UE 1604, an activation indication. The activation indication may be sent to UE 1604 to trigger UE 1604 to activate a subset of the ROs (e.g., configured via the RACH configuration sent at 1606).

In this example, and for a first option (“Option One” shown in FIG. 16), the activation indication may trigger the activation of a subset of ROs that are associated with one or more time periods corresponding to the indicated start time and length of time (and/or the indicated periodicity), which was communicated to the UE 1604 at 1608. For example, periods of RACH configuration 1614 that correspond to the indicated start time and length of time may include second SSB mapping cycle 1616-2 and third SSB mapping cycle 1616-3. Thus, the activation indication may trigger the activation of ROs, of RACH configuration 1614, associated with second SSB mapping cycle 1616-2 and third SSB mapping cycle 1616-3. In some cases where the periodicity (e.g., of association pattern periods) is indicated, ROs for similar time periods of other association pattern periods (not shown in FIG. 16), associated with RACH configuration 1614, may be activated as well.

In this example, and for a second option (“Option Two” shown in FIG. 16), the activation indication may trigger the activation of a subset of ROs that are not associated with one or more time periods that correspond to the indicated start time and length of time (and/or the indicated periodicity), which was communicated to the UE 1604 at 1608. For example, periods of RACH configuration 1614 that do not correspond to the indicated start time and length of time may include first SSB mapping cycle 1616-1 and fourth SSB mapping cycle 1616-4. Thus, the activation indication may trigger the activation of ROs, of RACH configuration 1614, associated with first SSB mapping cycle 1616-1 and fourth SSB mapping cycle 1616-4. In some cases where the periodicity (e.g., of association pattern periods) is indicated, ROs for similar time periods of other association pattern periods (not shown in FIG. 16), associated with RACH configuration 1614, may be activated as well.

At 1612, UE 1604 sends, to network entity 1602, a random access signal (e.g., such as MSG1 shown in RACH procedure 500a of FIG. 5A or MSGA/MSG1 shown in RACH procedure 500b of FIG. 5B). UE 1604 may send the random access signal to initiate a RACH procedure with network entity 1602. UE 1604 may send the random access signal in an RO of the subset of ROs that are activated via the activation indication (e.g., received by UE 1604).

Note that the process flow 1600 illustrated in FIG. 16 is described herein to facilitate an understanding of dynamic RO activation for a subset of ROs, and aspects of the present disclosure may be performed in various manners via alternative or additional signaling and/or operations. In certain aspects, the operations and/or signaling of FIG. 16 may occur in an order different from that described or depicted, and various actions, operations, and/or signaling may be added, omitted, or combined.

FIG. 17 depicts example time periods associated with an indicated offset time and duration, which may be identified for dynamic RO activation. In some cases, the time periods, associated with the indicated offset time and duration, may align in time with an association pattern period of a RACH configuration. In some other cases, however, the time periods, associated with the indicated offset time and duration, may not align in time with an association pattern period of a RACH configuration. Both cases are illustrated in FIG. 17.

For example, as shown, an example RACH configuration 1702 may include ROs 1704-1 through 1704-11 (individually referred to herein as “RO 1704” and collectively referred to herein as “ROs 1704”). A UE (not shown in FIG. 17) may receive an activation indication indicating to activate a subset of the ROs 1704. The UE may also receive an indication of a start time, a length of time, and a periodicity.

In a first case, shown at 1720, the start time may refer to the start of an association pattern period. The length of time may be indicated as 40 ms per time period. The periodicity may be indicated as 80 ms. In this example, an association pattern period 1706 of the RACH configuration may include two time periods where ROs of the RACH configuration are activated and two time periods where ROs of the RACH configuration are deactivated. For example, a first time period where the ROs of the RACH configuration are activated may begin at the start of association pattern period 1706 and last for 40 ms. A second time period where the ROs of the RACH configuration are activated may begin 80 ms after the start of the first time period and may last for 40 ms. Each of the time periods where ROs are not activated for random access communications may be 40 ms long. This pattern for the association pattern period 1706 may repeat for each association pattern period of the RACH configuration.

In a second case, shown at 1722, the start time may refer to the start of an association pattern period. The length of time may be indicated as 25 ms per time period. The periodicity may be indicated as 60 ms. In this example, an association pattern period 1706 of the RACH configuration may include three time periods where ROs of the RACH configuration are activated and three time periods where ROs of the RACH configuration are deactivated. For example, a first time period where the ROs of the RACH configuration are activated may begin at the start of association pattern period 1706 and last for 25 ms. A second time period where the ROs of the RACH configuration are activated may begin 60 ms after the start of the first time period and may last for 25 ms. A third time period where the ROs of the RACH configuration are activated may begin 60 ms after the start of the second time period and may last for 25 ms. The time periods where ROs are not activated for random access communications may be different lengths of time. For example, the first and second time periods where ROs of the RACH configuration are deactivated may last for 35 ms each. However, a third time period where ROs of the RACH configuration are deactivated may last for only 15 ms. The third time period where ROs of the RACH configuration are deactivated may end early based on the association pattern period 1706 ending at this time. This pattern for the association pattern period 1706 may repeat for each association pattern period of the RACH configuration.

### Example Operations of a User Equipment

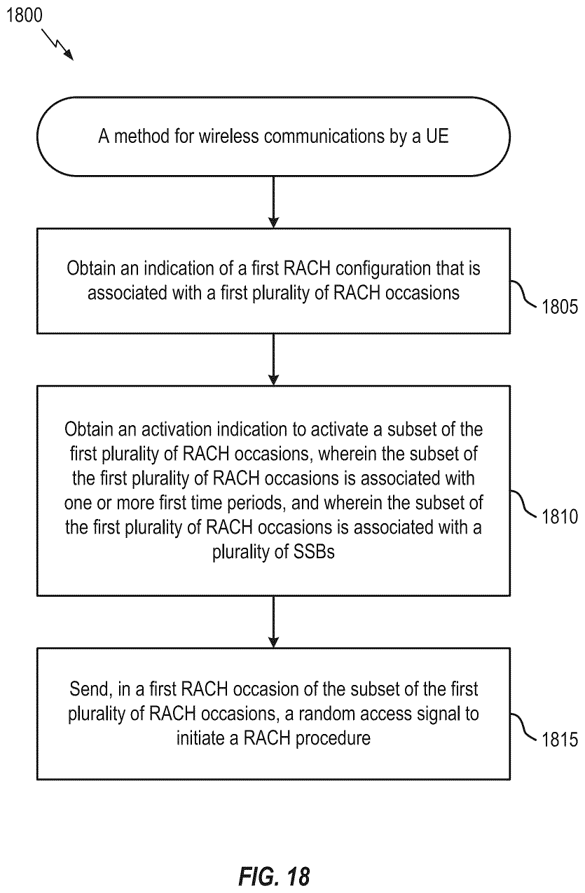

FIG. 18 shows a method 1800 for wireless communications by a UE, such as UE 104 of FIG. 1 or UE 304 of FIG. 3.

Method 1800 begins at block 1805 with obtaining an indication of a first RACH configuration that is associated with a first plurality of RACH occasions. Example obtaining of an indication of a first RACH configuration is depicted and described above with respect to step 608 of FIG. 6, step 1206 of FIG. 12, and step 1606 of FIG. 16.

Method 1800 then proceeds to block 1810 with obtaining an activation indication to activate a subset of the first plurality of RACH occasions, wherein the subset of the first plurality of RACH occasions is associated with one or more first time periods, and wherein the subset of the first plurality of RACH occasions is associated with a plurality of SSBs. Example obtaining of an activation indication is depicted and described above with respect to step 610 of FIG. 6, step 1208 of FIG. 12, and step 610 of FIG. 16.

Method 1800 then proceeds to block 1815 with sending, in a first RACH occasion of the subset of the first plurality of RACH occasions, a random access signal to initiate a RACH procedure. Example sending of a random access signal is depicted and described above with respect to step 612 of FIG. 6, step 1210 of FIG. 12, and step 1612 of FIG. 16.

In some aspects, the subset of the first plurality of RACH occasions comprises all RACH occasions corresponding to each time period of the one or more first time periods.

In some aspects, the one or more first time periods comprise: one or more association periods of the first RACH configuration; one or more SSB mapping cycles of the first RACH configuration; or one or more association pattern periods of the first RACH configuration.

In some aspects, the activation indication indicates a first index among a plurality of indexes; each index of the plurality of indexes is associated with a respective pattern of periods for a given period type; and the respective pattern of periods for the given period type of the first index comprises the one or more first time periods.

In some aspects, the activation indication indicates a first index among a plurality of indexes; each index of the plurality of indexes is associated with a respective pattern of a first given period type for a second given period type; and the respective pattern of the first given period type for the second given period type of the first index comprises the one or more first time periods.

In some aspects, the activation indication indicates a first index among a plurality of indexes; each index of the plurality of indexes is associated with: a respective pattern of periods, and a respective period type; and the one or more first time periods are associated with: the respective pattern of periods associated with the first index, and the respective period type associated with the first index.

In some aspects, block 1810 includes obtaining: a first indication of a first index among a plurality of indexes, wherein each index of the plurality of indexes is associated with a respective pattern of periods; and a second indication of a period type. In some aspects, the one or more first time periods are associated with: the respective pattern of periods associated with the first index, and the period type.

In some aspects, the activation indication indicates a first index among a plurality of indexes; each index of the plurality of indexes is mapped to a respective pattern of periods; and the one or more first time periods are associated with: the respective pattern of periods associated with the first index, and a first period type associated with the first RACH configuration.

In some aspects, method 1800 further includes obtaining an indication of an association between RACH configuration periodicity and period type, wherein the association associates a first RACH configuration periodicity with the first period type and the first RACH configuration is associated with the first RACH configuration periodicity.

In some aspects, block 1805 includes: obtaining an indication of multiple RACH configurations, wherein the multiple RACH configurations include the first RACH configuration, and wherein each RACH configuration of the multiple RACH configurations is associated with a respective plurality of RACH occasions.

In some aspects, the activation indication activates, for each respective RACH configuration of the multiple RACH configurations, a respective subset of the respective plurality of RACH occasions, wherein the respective subset of the respective plurality of RACH occasions is associated with respective one or more time periods; and for the first RACH configuration, the respective one or more time periods comprise the one or more first time periods.

In some aspects, for each respective RACH configuration of the multiple RACH configurations, the respective one or more time periods comprise: one or more association periods of the respective RACH configuration; one or more SSB mapping cycles of the respective RACH configuration; one or more association pattern periods of the respective RACH configuration; or one or more respective time durations associated with a start time and a length of time during each respective association pattern period of the one or more association pattern periods of the respective RACH configuration.

In some aspects, for each respective RACH configuration of the multiple RACH configurations, except the first RACH configuration, the respective one or more time periods overlap the one or more first time periods in a time domain.

In some aspects, the one or more first time periods for the first RACH configuration comprise: one or more first association periods of the first RACH configuration; one or more first SSB mapping cycles of the first RACH configuration; or one or more first association pattern periods of the first RACH configuration; or one or more time durations associated with a start time and a length of time during each respective association pattern period of the one or more association pattern periods of the first RACH configuration.

In some aspects, the activation indication activates, for each respective RACH configuration of a first subset of the multiple RACH configurations, a respective subset of the respective plurality of RACH occasions, wherein the respective subset of the respective plurality of RACH occasions is associated with respective one or more time periods; and for the first RACH configuration, the respective one or more time periods comprise the one or more first time periods.

In some aspects, each respective RACH configuration of the multiple RACH configurations is associated with a RRC mode of the UE; and the subset of the multiple RACH configurations is associated with an RRC mode of the UE.

In some aspects, method 1800 further includes obtaining an indication of the first subset of the multiple RACH configurations.

In some aspects, the activation indication is associated with the first RACH configuration; and the activation indication activates only the subset of the first plurality of RACH occasions, associated with the first RACH configuration, across the one or more first time periods.

In some aspects, method 1800 further includes obtaining an association indication that associates the activation indication with the first RACH configuration.

In some aspects, method 1800 further includes obtaining an indication of an offset time and a duration associated with each of the one or more first time periods.

In some aspects, a periodicity of the one or more first time periods is associated with an association pattern period of the first RACH configuration.

In some aspects, the offset time and the duration associated with each of the one or more first time periods are the offset time and the duration of each of the one or more first time periods.

In some aspects, the offset time and the duration associated with each of the one or more first time periods define time periods outside of the one or more first time periods.

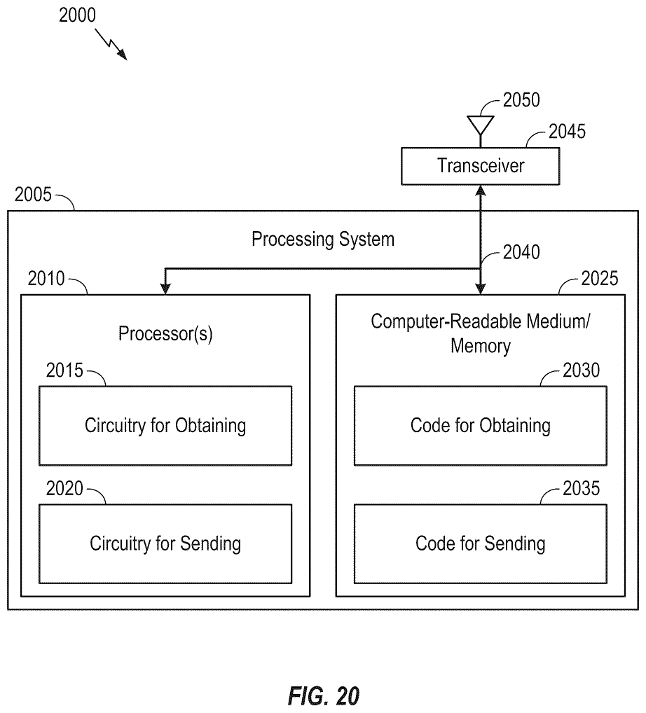

In some aspects, method 1800, or any aspect related to it, may be performed by an apparatus, such as communications device 2000 of FIG. 20, which includes various components operable, configured, or adapted to perform the method 1800. Communications device 2000 is described below in further detail.

Note that FIG. 18 is just one example of a method, and other methods including fewer, additional, or alternative operations are possible consistent with this disclosure.

### Example Operations of a Network Entity

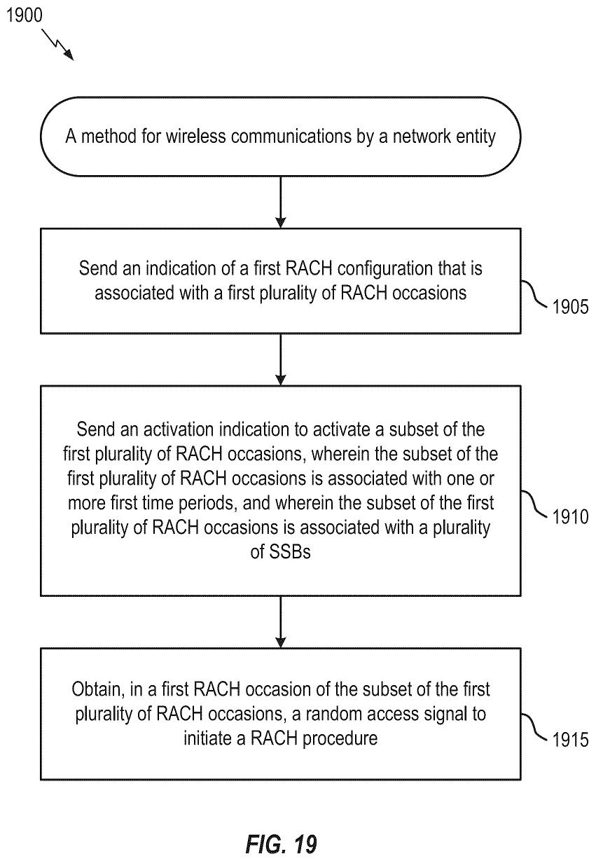

FIG. 19 shows a method 1900 for wireless communications by a network entity, such as BS 102 of FIG. 1, a first network entity 300 or second network entity 302 of FIG. 3, or a disaggregated base station as discussed with respect to FIG. 2.

Method 1900 begins at block 1905 with sending an indication of a first RACH configuration that is associated with a first plurality of RACH occasions. Example sending of an indication of a first RACH configuration is depicted and described above with respect to step 608 of FIG. 6, step 1206 of FIG. 12, and step 1606 of FIG. 16.

Method 1900 then proceeds to block 1910 with sending an activation indication to activate a subset of the first plurality of RACH occasions, wherein the subset of the first plurality of RACH occasions is associated with one or more first time periods, and wherein the subset of the first plurality of RACH occasions is associated with a plurality of SSBs. Example sending of an activation indication is depicted and described above with respect to step 610 of FIG. 6, step 1208 of FIG. 12, and step 610 of FIG. 16.

Method 1900 then proceeds to block 1915 with obtaining, in a first RACH occasion of the subset of the first plurality of RACH occasions, a random access signal to initiate a RACH procedure. Example obtaining of a random access signal is depicted and described above with respect to step 612 of FIG. 6, step 1210 of FIG. 12, and step 1612 of FIG. 16.

In some aspects, the subset of the first plurality of RACH occasions comprises all RACH occasions corresponding to each time period of the one or more first time periods.

In some aspects, the one or more first time periods comprise: one or more association periods of the first RACH configuration; one or more SSB mapping cycles of the first RACH configuration; or one or more association pattern periods of the first RACH configuration.

In some aspects, the activation indication indicates a first index among a plurality of indexes; each index of the plurality of indexes is associated with a respective pattern of periods for a given period type; and the respective pattern of periods for the given period type of the first index comprises the one or more first time periods.

In some aspects, the activation indication indicates a first index among a plurality of indexes; each index of the plurality of indexes is associated with a respective pattern of a first given period type for a second given period type; and the respective pattern of the first given period type for the second given period type of the first index comprises the one or more first time periods.

In some aspects, the activation indication indicates a first index among a plurality of indexes; each index of the plurality of indexes is associated with: a respective pattern of periods, and a respective period type; and the one or more first time periods are associated with: the respective pattern of periods associated with the first index, and the respective period type associated with the first index.

In some aspects, block 1910 includes sending: a first indication of a first index among a plurality of indexes, wherein each index of the plurality of indexes is associated with a respective pattern of periods; and a second indication of a period type. In some aspects, the one or more first time periods are associated with: the respective pattern of periods associated with the first index, and the period type.

In some aspects, the activation indication indicates a first index among a plurality of indexes; each index of the plurality of indexes is mapped to a respective pattern of periods; and the one or more first time periods are associated with: the respective pattern of periods associated with the first index, and a first period type associated with the first RACH configuration.

In certain aspects, method 1900 further includes sending an indication of an association between RACH configuration periodicity and period type, wherein the association associates a first RACH configuration periodicity with the first period type and the first RACH configuration is associated with the first RACH configuration periodicity.

In some aspects, sending an indication of multiple RACH configurations, including the first RACH configuration, each RACH configuration of the multiple RACH configurations being associated with a respective plurality of RACH occasions.

In some aspects, the activation indication activates, for each respective RACH configuration of the multiple RACH configurations, a respective subset of the respective plurality of RACH occasions, wherein the respective subset of the respective plurality of RACH occasions is associated with respective one or more time periods; and for the first RACH configuration, the respective one or more time periods comprise the one or more first time periods.

In some aspects, for each respective RACH configuration of the multiple RACH configurations, the respective one or more time periods comprise: one or more association periods of the respective RACH configuration; one or more SSB mapping cycles of the respective RACH configuration; one or more association pattern periods of the respective RACH configuration; or one or more respective time durations associated with a start time and a length of time during each respective association pattern period of the one or more association pattern periods of the respective RACH configuration.

In some aspects, for each respective RACH configuration of the multiple RACH configurations, except the first RACH configuration, the respective one or more time periods overlap the one or more first time periods in a time domain.

In some aspects, the one or more first time periods for the first RACH configuration comprise: one or more first association periods of the first RACH configuration; one or more first SSB mapping cycles of the first RACH configuration; or one or more first association pattern periods of the first RACH configuration; or one or more time durations associated with a start time and a length of time during each respective association pattern period of the one or more association pattern periods of the first RACH configuration.

In some aspects, the activation indication activates, for each respective RACH configuration of a first subset of the multiple RACH configurations, a respective subset of the respective plurality of RACH occasions, wherein the respective subset of the respective plurality of RACH occasions is associated with respective one or more time periods; and for the first RACH configuration, the respective one or more time periods comprise the one or more first time periods.

In some aspects, each respective RACH configuration of the multiple RACH configurations is associated with a RRC mode of a UE; and the subset of the multiple RACH configurations is associated with an RRC mode of the UE.

In certain aspects, method 1900 further includes sending an indication of the first subset of the multiple RACH configurations.

In some aspects, the activation indication is associated with the first RACH configuration; and the activation indication activates only the subset of the first plurality of RACH occasions, associated with the first RACH configuration, across the one or more first time periods.

In certain aspects, method 1900 further includes sending an association indication that associates the activation indication with the first RACH configuration.

In certain aspects, method 1900 further includes sending an indication of an offset time and a duration associated with each of the one or more first time periods.

In some aspects, a periodicity of the one or more first time periods is associated with an association pattern period of the first RACH configuration.

In some aspects, the offset time and the duration associated with each of the one or more first time periods are the offset time and the duration of each of the one or more first time periods.

In some aspects, the offset time and the duration associated with each of the one or more first time periods define time periods outside of the one or more first time periods.

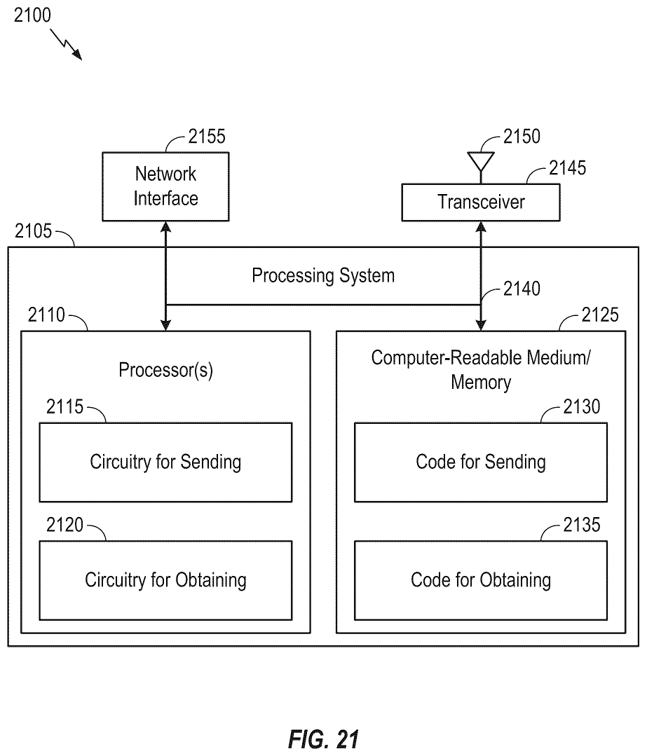

In some aspects, method 1900, or any aspect related to it, may be performed by an apparatus, such as communications device 2100 of FIG. 21, which includes various components operable, configured, or adapted to perform the method 1900. Communications device 2100 is described below in further detail.

Note that FIG. 19 is just one example of a method, and other methods including fewer, additional, or alternative operations are possible consistent with this disclosure.

### Example Communications Devices

FIG. 20 depicts aspects of an example communications device 2000 configured for wireless communications. In some aspects, communications device 2000 is a user equipment, such as UE 104 described above with respect to FIG. 1 or UE 304 described with respect to FIG. 3.

The communications device 2000 includes a processing system 2005 coupled to a transceiver 2045 (e.g., a transmitter and/or a receiver). The transceiver 2045 is configured to transmit and receive signals for the communications device 2000 via an antenna 2050, such as the various signals as described herein. The processing system 2005 may be configured to perform processing functions for the communications device 2000, including processing signals received and/or to be transmitted by the communications device 2000.

The processing system 2005 includes one or more processors 2010 and a computer-readable medium/memory 2025. In various aspects, the one or more processors 2010 may be representative of the one or more processors 318 described with respect to FIG. 3. The one or more processors 2010 are coupled to a computer-readable medium/memory 2025 via a bus 2040. In some aspects, the computer-readable medium/memory 2025 may be representative of the one or more memories 320 described with respect to FIG. 3. The computer-readable medium/memory 2025 is a non-transitory computer-readable medium/memory. In certain aspects, the computer-readable medium/memory 2025 is configured to store instructions (e.g., computer-executable code), that when executed by the one or more processors 2010, cause the one or more processors 2010 to perform the method 1800 described with respect to FIG. 18, or any aspect related to it, including any operations described in relation to FIG. 18. Note that reference to a processor performing a function of communications device 2000 may include one or more processors performing that function of communications device 2000, such as in a distributed fashion.

In the depicted example, computer-readable medium/memory 2025 stores code (e.g., executable instructions), including code for obtaining 2030 and code for sending 2035. Processing of the code for obtaining 2030 and code for sending 2035 may enable and cause the communications device 2000 to perform the method 1800 described with respect to FIG. 18, or any aspect related to it. For example, in some aspects, code for obtaining 2030 includes code for obtaining an indication of a first RACH configuration that is associated with a first plurality of RACH occasions. In some aspects, code for obtaining 2030 includes code for obtaining an activation indication to activate a subset of the first plurality of RACH occasions, wherein the subset of the first plurality of RACH occasions is associated with one or more first time periods, and wherein the subset of the first plurality of RACH occasions is associated with a plurality of SSBs. In some aspects, code for sending 2035 includes code for sending, in a first RACH occasion of the subset of the first plurality of RACH occasions, a random access signal to initiate a RACH procedure.

The one or more processors 2010 include circuitry configured to implement (e.g., execute) the code stored in the computer-readable medium/memory 2025, including circuitry for obtaining 2015 and circuitry for sending 2020. Processing with circuitry for obtaining 2015 and circuitry for sending 2020 may enable and cause the communications device 2000 to perform the method 1800 described with respect to FIG. 18, or any aspect related to it. For example, in some aspects, circuitry for obtaining 2015 includes circuitry for obtaining an indication of a first RACH configuration that is associated with a first plurality of RACH occasions. In some aspects, circuitry for obtaining 2015 includes circuitry for obtaining an activation indication to activate a subset of the first plurality of RACH occasions, wherein the subset of the first plurality of RACH occasions is associated with one or more first time periods, and wherein the subset of the first plurality of RACH occasions is associated with a plurality of SSBs. In some aspects, circuitry for sending 2020 includes circuitry for sending, in a first RACH occasion of the subset of the first plurality of RACH occasions, a random access signal to initiate a RACH procedure.

More generally, means for communicating, transmitting, sending or outputting for transmission may include the one or more transceivers 324, one or more antenna 322 and/or processing system 316 of the UE 304 illustrated in FIG. 3, transceiver 2045 and/or antenna 2050 of the communications device 2000 in FIG. 20, and/or one or more processors 2010 of the communications device 2000 in FIG. 20. Means for communicating, receiving or obtaining may include the one or more transceivers 324, one or more antennas 322, and/or processing system 316 of the UE 304 illustrated in FIG. 3, transceiver 2045 and/or antenna 2050 of the communications device 2000 in FIG. 20, and/or one or more processors 2010 of the communications device 2000 in FIG. 20.

FIG. 21 depicts aspects of an example communications device configured for wireless communications. In some aspects, communications device 2100 is a network entity, such as BS 102 of FIG. 1, first network entity 300 or second network entity 302 of FIG. 3, or a disaggregated base station as discussed with respect to FIG. 2.

The communications device 2100 includes a processing system 2105 coupled to a transceiver 2145 (e.g., a transmitter and/or a receiver) and/or a network interface 2155. The transceiver 2145 is configured to transmit and receive signals for the communications device 2100 via an antenna 2150, such as the various signals as described herein. The network interface 2155 is configured to obtain and send signals for the communications device 2100 via communications link(s), such as a backhaul link, midhaul link, and/or fronthaul link as described herein, such as with respect to FIG. 2. The processing system 2105 may be configured to perform processing functions for the communications device 2100, including processing signals received and/or to be transmitted by the communications device 2100.

The processing system 2105 includes one or more processors 2110 and a computer-readable medium/memory 2125. In various aspects, one or more processors 2110 may be representative of the one or more processors 308, as described with respect to FIG. 3. The one or more processors 2110 are coupled to the computer-readable medium/memory 2125 via a bus 2140. In certain aspects, the computer-readable medium/memory 2125 is configured to store instructions (e.g., computer-executable code), including code for sending 2130 and code for obtaining 2135, that when executed by the one or more processors 2110, cause the one or more processors 2110 to perform the method 1900 described with respect to FIG. 19, or any aspect related to it, including any operations described in relation to FIG. 19. The computer-readable medium/memory 2125 is a non-transitory computer-readable medium/memory. Note that reference to a processor of communications device 2100 performing a function may include one or more processors of communications device 2100 performing that function, such as in a distributed fashion.

In the depicted example, the computer-readable medium/memory 2125 stores code (e.g., executable instructions), including code for sending 2130 and code for obtaining 2135. Processing of the code for sending 2130 and code for obtaining 2135 may enable and cause the communications device 2100 to perform the method 1900 described with respect to FIG. 19, or any aspect related to it. For example, in some aspects, code for sending 2130 includes code for sending an indication of a first RACH configuration that is associated with a first plurality of RACH occasions. In some aspects, code for sending 2130 includes code for sending an activation indication to activate a subset of the first plurality of RACH occasions, wherein the subset of the first plurality of RACH occasions is associated with one or more first time periods, and wherein the subset of the first plurality of RACH occasions is associated with a plurality of SSBs. In some aspects, code for obtaining 2135 includes code for obtaining, in a first RACH occasion of the subset of the first plurality of RACH occasions, a random access signal to initiate a RACH procedure.

The one or more processors 2110 include circuitry configured to implement (e.g., execute) the code stored in the computer-readable medium/memory 2125, including circuitry for sending 2115 and circuitry for obtaining 2120. Processing with circuitry for sending 2115 and circuitry for obtaining 2120 may enable and cause the communications device 2100 to perform the method 1900 described with respect to FIG. 19, or any aspect related to it. For example, in some aspects, circuitry for sending 2115 includes circuitry for sending an indication of a first RACH configuration that is associated with a first plurality of RACH occasions. In some aspects, circuitry for sending 2115 includes circuitry for sending an activation indication to activate a subset of the first plurality of RACH occasions, wherein the subset of the first plurality of RACH occasions is associated with one or more first time periods, and wherein the subset of the first plurality of RACH occasions is associated with a plurality of SSBs. In some aspects, circuitry for obtaining 2120 includes circuitry for obtaining, in a first RACH occasion of the subset of the first plurality of RACH occasions, a random access signal to initiate a RACH procedure.

Various components of the communications device 2100 may provide means for performing the method 1900 described with respect to FIG. 19, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 2145, antenna 2150, and/or network interface 2155 of the communications device 2100 in FIG. 21, and/or one or more processors 2110 of the communications device 2100 in FIG. 21. Means for communicating, receiving or obtaining may include the one or more transceivers 312, one or more antennas 314, and/or processing system 306 of the first network entity 300 or the second network entity 302 illustrated in FIG. 3, transceiver 2145, antenna 2150, and/or network interface 2155 of the communications device 2100 in FIG. 21, and/or one or more processors 2110 of the communications device 2100 in FIG. 21.

### Example Clauses

Implementation examples are described in the following numbered clauses:

Clause 1: A method for wireless communications by a UE comprising: obtaining an indication of a first RACH configuration that is associated with a first plurality of RACH occasions; obtaining an activation indication to activate a subset of the first plurality of RACH occasions, wherein the subset of the first plurality of RACH occasions is associated with one or more first time periods, and wherein the subset of the first plurality of RACH occasions is associated with a plurality of SSBs; and sending, in a first RACH occasion of the subset of the first plurality of RACH occasions, a random access signal to initiate a RACH procedure.

Clause 2: The method of Clause 1, wherein the subset of the first plurality of RACH occasions comprises all RACH occasions corresponding to each time period of the one or more first time periods.

Clause 3: The method of any one of Clauses 1-2, wherein the one or more first time periods comprise: one or more association periods of the first RACH configuration; one or more SSB mapping cycles of the first RACH configuration; or one or more association pattern periods of the first RACH configuration.

Clause 4: The method of any one of Clauses 1-3, wherein: the activation indication indicates a first index among a plurality of indexes; each index of the plurality of indexes is associated with a respective pattern of periods for a given period type; and the respective pattern of periods for the given period type of the first index comprises the one or more first time periods.

Clause 5: The method of any one of Clauses 1-4, wherein: the activation indication indicates a first index among a plurality of indexes; each index of the plurality of indexes is associated with: a respective pattern of periods, and a respective period type; and the one or more first time periods are associated with: the respective pattern of periods associated with the first index, and the respective period type associated with the first index.

Clause 6: The method of any one of Clauses 1-5, wherein: obtaining the activation indication comprises obtaining: a first indication of a first index among a plurality of indexes, wherein each index of the plurality of indexes is associated with a respective pattern of periods, and a second indication of a period type; and the one or more first time periods are associated with: the respective pattern of periods associated with the first index, and the period type.

Clause 7: The method of any one of Clauses 1-6, wherein: the activation indication indicates a first index among a plurality of indexes; each index of the plurality of indexes is mapped to a respective pattern of periods; and the one or more first time periods are associated with: the respective pattern of periods associated with the first index, and a first period type associated with the first RACH configuration.

Clause 8: The method of Clause 7, further comprising obtaining an indication of an association between RACH configuration periodicity and period type, wherein the association associates a first RACH configuration periodicity with the first period type and the first RACH configuration is associated with the first RACH configuration periodicity.

Clause 9: The method of any one of Clauses 1-8, wherein obtaining the indication of the first RACH configuration comprises: obtaining an indication of multiple RACH configurations, wherein the multiple RACH configurations include the first RACH configuration, and wherein each RACH configuration of the multiple RACH configurations is associated with a respective plurality of RACH occasions.

Clause 10: The method of Clause 9, wherein: the activation indication activates, for each respective RACH configuration of the multiple RACH configurations, a respective subset of the respective plurality of RACH occasions, wherein the respective subset of the respective plurality of RACH occasions is associated with respective one or more time periods; and for the first RACH configuration, the respective one or more time periods comprise the one or more first time periods.

Clause 11: The method of Clause 10, wherein, for each respective RACH configuration of the multiple RACH configurations, the respective one or more time periods comprise: one or more association periods of the respective RACH configuration; one or more SSB mapping cycles of the respective RACH configuration; one or more association pattern periods of the respective RACH configuration; or one or more respective time durations associated with a start time and a length of time during each respective association pattern period of the one or more association pattern periods of the respective RACH configuration.

Clause 12: The method of Clause 11, wherein for each respective RACH configuration of the multiple RACH configurations, except the first RACH configuration, the respective one or more time periods overlap the one or more first time periods in a time domain.

Clause 13: The method of Clause 12, wherein the one or more first time periods for the first RACH configuration comprise: one or more first association periods of the first RACH configuration; one or more first SSB mapping cycles of the first RACH configuration; or one or more first association pattern periods of the first RACH configuration; or one or more time durations associated with a start time and a length of time during each respective association pattern period of the one or more association pattern periods of the first RACH configuration.

Clause 14: The method of Clause 9, wherein: the activation indication activates, for each respective RACH configuration of a first subset of the multiple RACH configurations, a respective subset of the respective plurality of RACH occasions, wherein the respective subset of the respective plurality of RACH occasions is associated with respective one or more time periods; and for the first RACH configuration, the respective one or more time periods comprise the one or more first time periods.

Clause 15: The method of Clause 14, wherein: each respective RACH configuration of the multiple RACH configurations is associated with a RRC mode of the UE; and the subset of the multiple RACH configurations is associated with an RRC mode of the UE.

Clause 16: The method of Clause 14, further comprising obtaining an indication of the first subset of the multiple RACH configurations.

Clause 17: The method of Clause 9, wherein: the activation indication is associated with the first RACH configuration; and the activation indication activates only the subset of the first plurality of RACH occasions, associated with the first RACH configuration, across the one or more first time periods.

Clause 18: The method of Clause 17, further comprising obtaining an association indication that associates the activation indication with the first RACH configuration.

Clause 19: The method of any one of Clauses 1-18, further comprising obtaining an indication of an offset time and a duration associated with each of the one or more first time periods.

Clause 20: The method of Clause 19, wherein a periodicity of the one or more first time periods is associated with an association pattern period of the first RACH configuration.

Clause 21: The method of Clause 19, wherein the offset time and the duration associated with each of the one or more first time periods are the offset time and the duration of each of the one or more first time periods.

Clause 22: The method of Clause 19, wherein the offset time and the duration associated with each of the one or more first time periods define time periods outside of the one or more first time periods.

Clause 23: A method for wireless communications by a network entity comprising: sending an indication of a first RACH configuration that is associated with a first plurality of RACH occasions; sending an activation indication to activate a subset of the first plurality of RACH occasions, wherein the subset of the first plurality of RACH occasions is associated with one or more first time periods, and wherein the subset of the first plurality of RACH occasions is associated with a plurality of SSBs; and obtaining, in a first RACH occasion of the subset of the first plurality of RACH occasions, a random access signal to initiate a RACH procedure.

Clause 24: The method of Clause 23, wherein the subset of the first plurality of RACH occasions comprises all RACH occasions corresponding to each time period of the one or more first time periods.

Clause 25: The method of any one of Clauses 23-24, wherein the one or more first time periods comprise: one or more association periods of the first RACH configuration; one or more SSB mapping cycles of the first RACH configuration; or one or more association pattern periods of the first RACH configuration.

Clause 26: The method of any one of Clauses 23-25, wherein: the activation indication indicates a first index among a plurality of indexes; each index of the plurality of indexes is associated with a respective pattern of periods for a given period type; and the respective pattern of periods for the given period type of the first index comprises the one or more first time periods.

Clause 27: The method of any one of Clauses 23-26, wherein: the activation indication indicates a first index among a plurality of indexes; each index of the plurality of indexes is associated with: a respective pattern of periods, and a respective period type; and the one or more first time periods are associated with: the respective pattern of periods associated with the first index, and the respective period type associated with the first index.

Clause 28: The method of any one of Clauses 23-27, wherein: sending the activation indication comprises sending: a first indication of a first index among a plurality of indexes, wherein each index of the plurality of indexes is associated with a respective pattern of periods; and a second indication of a period type; and the one or more first time periods are associated with: the respective pattern of periods associated with the first index, and the period type.

Clause 29: The method of any one of Clauses 23-28, wherein: the activation indication indicates a first index among a plurality of indexes; each index of the plurality of indexes is mapped to a respective pattern of periods; and the one or more first time periods are associated with: the respective pattern of periods associated with the first index, and a first period type associated with the first RACH configuration.

Clause 30: The method of Clause 29, further comprising sending an indication of an association between RACH configuration periodicity and period type, wherein the association associates a first RACH configuration periodicity with the first period type and the first RACH configuration is associated with the first RACH configuration periodicity.

Clause 31: The method of any one of Clauses 23-30, wherein causing the network entity to send the indication of the first RACH configuration comprises sending an indication of multiple RACH configurations, including the first RACH configuration, each RACH configuration of the multiple RACH configurations being associated with a respective plurality of RACH occasions.

Clause 32: The method of Clause 31, wherein: the activation indication activates, for each respective RACH configuration of the multiple RACH configurations, a respective subset of the respective plurality of RACH occasions, wherein the respective subset of the respective plurality of RACH occasions is associated with respective one or more time periods; and for the first RACH configuration, the respective one or more time periods comprise the one or more first time periods.

Clause 33: The method of Clause 32, wherein, for each respective RACH configuration of the multiple RACH configurations, the respective one or more time periods comprise: one or more association periods of the respective RACH configuration; one or more SSB mapping cycles of the respective RACH configuration; one or more association pattern periods of the respective RACH configuration; or one or more respective time durations associated with a start time and a length of time during each respective association pattern period of the one or more association pattern periods of the respective RACH configuration.

Clause 34: The method of Clause 33, wherein for each respective RACH configuration of the multiple RACH configurations, except the first RACH configuration, the respective one or more time periods overlap the one or more first time periods in a time domain.

Clause 35: The method of Clause 34, wherein the one or more first time periods for the first RACH configuration comprise: one or more first association periods of the first RACH configuration; one or more first SSB mapping cycles of the first RACH configuration; or one or more first association pattern periods of the first RACH configuration; or one or more time durations associated with a start time and a length of time during each respective association pattern period of the one or more association pattern periods of the first RACH configuration.

Clause 36: The method of Clause 31, wherein: the activation indication activates, for each respective RACH configuration of a first subset of the multiple RACH configurations, a respective subset of the respective plurality of RACH occasions, wherein the respective subset of the respective plurality of RACH occasions is associated with respective one or more time periods; and for the first RACH configuration, the respective one or more time periods comprise the one or more first time periods.

Clause 37: The method of Clause 36, wherein: each respective RACH configuration of the multiple RACH configurations is associated with a RRC mode of a UE; and the subset of the multiple RACH configurations is associated with an RRC mode of the UE.

Clause 38: The method of Clause 36, further comprising sending an indication of the first subset of the multiple RACH configurations.

Clause 39: The method of Clause 31, wherein: the activation indication is associated with the first RACH configuration; and the activation indication activates only the subset of the first plurality of RACH occasions, associated with the first RACH configuration, across the one or more first time periods.

Clause 40: The method of Clause 39, further comprising sending an association indication that associates the activation indication with the first RACH configuration.

Clause 41: The method of any one of Clauses 23-40, further comprising sending an indication of an offset time and a duration associated with each of the one or more first time periods.

Clause 42: The method of Clause 41, wherein a periodicity of the one or more first time periods is associated with an association pattern period of the first RACH configuration.

Clause 43: The method of Clause 41, wherein the offset time and the duration associated with each of the one or more first time periods are the offset time and the duration of each of the one or more first time periods.

Clause 44: The method of Clause 41, wherein the offset time and the duration associated with each of the one or more first time periods define time periods outside of the one or more first time periods.

Clause 45: The method of any one of Clauses 1-3, wherein: the activation indication indicates a first index among a plurality of indexes; each index of the plurality of indexes is associated with a respective pattern of a first given period type for a second given period type; and the respective pattern of the first given period type for the second given period type of the first index comprises the one or more first time periods.

Clause 46: The method of any one of Clauses 23-25, wherein: the activation indication indicates a first index among a plurality of indexes; each index of the plurality of indexes is associated with a respective pattern of a first given period type for a second given period type; and the respective pattern of the first given period type for the second given period type of the first index comprises the one or more first time periods.

Clause 47: One or more apparatuses, comprising: one or more memories comprising executable instructions; and one or more processors configured to execute the executable instructions and cause the one or more apparatuses to perform a method in accordance with any one of Clauses 1-46.

Clause 48: One or more apparatuses configured for wireless communications, comprising: one or more memories; and one or more processors, coupled to the one or more memories, configured to cause the one or more apparatuses to perform a method in accordance with any one of Clauses 1-46.

Clause 49: One or more apparatuses configured for wireless communications, comprising: one or more memories; and one or more processors, coupled to the one or more memories, configured to perform a method in accordance with any one of Clauses 1-46.

Clause 50: One or more apparatuses, comprising means for performing a method in accordance with any one of Clauses 1-46.

Clause 51: One or more non-transitory computer-readable media comprising executable instructions that, when executed by one or more processors of one or more apparatuses, cause the one or more apparatuses to perform a method in accordance with any one of Clauses 1-46.

Clause 52: One or more computer program products embodied on one or more computer-readable storage media comprising code for performing a method in accordance with any one of Clauses 1-46.

Clause 53: One or more apparatuses configured for wireless communications, comprising: a processing system that includes one or more processors and one or more memories coupled with the one or more processors, the processing system configured to cause the one or more apparatuses to perform a method in accordance with any one of Clauses 1-46.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain an indication of a first random access channel (RACH) configuration that is associated with a first plurality of RACH occasions;
obtain an activation indication to activate a subset of the first plurality of RACH occasions, wherein the subset of the first plurality of RACH occasions is associated with one or more first time periods, and wherein the subset of the first plurality of RACH occasions is associated with a plurality of synchronization signal blocks (SSBs); and
send, in a first RACH occasion of the subset of the first plurality of RACH occasions, a random access signal to initiate a RACH procedure.

2. The apparatus of claim 1, wherein the subset of the first plurality of RACH occasions comprises all RACH occasions corresponding to each time period of the one or more first time periods.

3. The apparatus of claim 1, wherein the one or more first time periods comprise:
one or more association periods of the first RACH configuration;
one or more SSB mapping cycles of the first RACH configuration; or
one or more association pattern periods of the first RACH configuration.

4. The apparatus of claim 1, wherein:
the activation indication indicates a first index among a plurality of indexes;
each index of the plurality of indexes is associated with a respective pattern of periods for a given period type; and
the respective pattern of periods for the given period type of the first index comprises the one or more first time periods.

5. The apparatus of claim 1, wherein:
the activation indication indicates a first index among a plurality of indexes;
each index of the plurality of indexes is associated with a respective pattern of a first given period type for a second given period type; and
the respective pattern of the first given period type for the second given period type of the first index comprises the one or more first time periods.

6. The apparatus of claim 1, wherein:
the activation indication indicates a first index among a plurality of indexes;
each index of the plurality of indexes is associated with:
a respective pattern of periods, and
a respective period type; and
the one or more first time periods are associated with:
the respective pattern of periods associated with the first index, and
the respective period type associated with the first index.

7. The apparatus of claim 1, wherein:
to cause the UE to obtain the activation indication, the processing system is configured to cause the UE to obtain:
a first indication of a first index among a plurality of indexes, wherein each index of the plurality of indexes is associated with a respective pattern of periods; and
a second indication of a period type; and
the one or more first time periods are associated with:
the respective pattern of periods associated with the first index, and
the period type.

8. The apparatus of claim 1, wherein:
the activation indication indicates a first index among a plurality of indexes;
each index of the plurality of indexes is mapped to a respective pattern of periods; and
the one or more first time periods are associated with:
the respective pattern of periods associated with the first index, and
a first period type associated with the first RACH configuration.

9. The apparatus of claim 8, wherein:
the processing system is configured to cause the UE to obtain an indication of an association between RACH configuration periodicity and period type;
the association associates a first RACH configuration periodicity with the first period type; and
the first RACH configuration is associated with the first RACH configuration periodicity.

10. The apparatus of claim 1, wherein to cause the UE to obtain the indication of the first RACH configuration, the processing system is configured to cause the UE to:
obtain an indication of multiple RACH configurations, wherein the multiple RACH configurations include the first RACH configuration, and wherein each RACH configuration of the multiple RACH configurations is associated with a respective plurality of RACH occasions.

11. The apparatus of claim 10, wherein:
the activation indication activates, for each respective RACH configuration of the multiple RACH configurations, a respective subset of the respective plurality of RACH occasions, wherein the respective subset of the respective plurality of RACH occasions is associated with respective one or more time periods; and
for the first RACH configuration, the respective one or more time periods comprise the one or more first time periods.

12. The apparatus of claim 11, wherein, for each respective RACH configuration of the multiple RACH configurations, the respective one or more time periods comprise:
one or more association periods of the respective RACH configuration;
one or more SSB mapping cycles of the respective RACH configuration;
one or more association pattern periods of the respective RACH configuration; or
one or more respective time durations associated with a start time and a length of time during each respective association pattern period of the one or more association pattern periods of the respective RACH configuration.

13. The apparatus of claim 12, wherein for each respective RACH configuration of the multiple RACH configurations, except the first RACH configuration, the respective one or more time periods overlap the one or more first time periods in a time domain.

14. The apparatus of claim 10, wherein:
the activation indication activates, for each respective RACH configuration of a first subset of the multiple RACH configurations, a respective subset of the respective plurality of RACH occasions, wherein the respective subset of the respective plurality of RACH occasions is associated with respective one or more time periods; and
for the first RACH configuration, the respective one or more time periods comprise the one or more first time periods.

15. The apparatus of claim 14, wherein:
each respective RACH configuration of the multiple RACH configurations is associated with a radio resource control (RRC) mode of the UE; and
the subset of the multiple RACH configurations is associated with an RRC mode of the UE.

16. The apparatus of claim 10, wherein:
the activation indication is associated with the first RACH configuration; and
the activation indication activates only the subset of the first plurality of RACH occasions, associated with the first RACH configuration, across the one or more first time periods.

17. The apparatus of claim 1, wherein the processing system is configured to cause the UE to obtain an indication of an offset time and a duration associated with each of the one or more first time periods.

18. The apparatus of claim 17, wherein:
the offset time and the duration associated with each of the one or more first time periods are the offset time and the duration of each of the one or more first time periods; or
the offset time and the duration associated with each of the one or more first time periods define time periods outside of the one or more first time periods.

19. A method for wireless communications by a user equipment (UE) comprising:
obtaining an indication of a first random access channel (RACH) configuration that is associated with a first plurality of RACH occasions;
obtaining an activation indication to activate a subset of the first plurality of RACH occasions, wherein the subset of the first plurality of RACH occasions is associated with one or more first time periods, and wherein the subset of the first plurality of RACH occasions is associated with a plurality of synchronization signal blocks (SSBs); and
sending, in a first RACH occasion of the subset of the first plurality of RACH occasions, a random access signal to initiate a RACH procedure.

20. One or more non-transitory computer-readable media comprising executable instructions that, when executed by one or more processors of an apparatus, cause the apparatus to perform operations comprising:
obtaining an indication of a first random access channel (RACH) configuration that is associated with a first plurality of RACH occasions;
obtaining an activation indication to activate a subset of the first plurality of RACH occasions, wherein the subset of the first plurality of RACH occasions is associated with one or more first time periods, and wherein the subset of the first plurality of RACH occasions is associated with a plurality of synchronization signal blocks (SSBs); and
sending, in a first RACH occasion of the subset of the first plurality of RACH occasions, a random access signal to initiate a RACH procedure.
